(19) United States
(12) Patent Application Publication
(10) Pub. No.: US 2011/0157521 A1
(43) Pub. Date: Jun. 30, 2011

(54) LIQUID CRYSTAL DISPLAY

(75) Inventors: Katsusuke Shimazaki, Osaka (JP); Yoichi Ogawa, Osaka (JP); Eiji Koyama, Osaka (JP); Masataka Sato, Tokyo (JP)

(73) Assignee: HITACHI MAXELL, LTD., Ibaraki-shi, Osaka (JP)

(21) Appl. No.: 13/055,158

(22) PCT Filed: Jul. 22, 2009
(86) PCT No.: PCT/JP2009/003430

§ 371 Date: Mar. 17, 2011

(30) Foreign Application Priority Data
Jul. 22, 2008 (JP) 2008-188169

(51) Int. Cl. G02F 1/13357

(52) U.S. Cl. 349/65; 349/62

(57) ABSTRACT

A liquid crystal display according to the present invention includes a light source, an optical control member, and a liquid crystal display panel. Said optical control member includes a base having optical transparency and a plurality of linear structures provided on said base, a section of the linear structure orthogonal to its extending direction includes a first sectional portion having a triangular shape defined by first to third sides, and a second sectional portion having a plurality of triangular structures each having a smaller area than the first sectional portion and defined by fourth to sixth sides, the first side of the first sectional portion is abutted on and parallel to a surface of said base, the second sectional portion is provided on the second side of the first sectional portion, and the fourth side of the second sectional portion is abutted on and parallel to the second side of the first sectional portion. Said liquid crystal display panel having a polarizing plate arranged in a direction to transmit a P-polarized component is provided on the side of the light output surface of said optical control member. Therefore, the liquid crystal display according to the present invention can solve the problems of color separation and insufficient luminance.

### TECHNICAL FIELD

The present invention relates to a liquid crystal display including an optical control member that controls the advancing direction of an incident beam of light.

### BACKGROUND ART

Conventional illumination devices (such as a backlight unit in a liquid crystal display) are equipped with mechanisms for controlling the spreading or luminance of a light beam from a light source. Most illumination devices include an optical control member used to control the directivity of light. The optical control member has optical transparency and the function of arranging incident light in a prescribed direction or diffusing incident light.

A typical example of an optical control member having the function of arranging incident light in a prescribed direction or the function of controlling optical directivity is a prism sheet (see JP 10-506500 A). The prism sheet includes a sheet type base and a plurality of optical structures arranged on the base. Typical examples of the optical structure include a prism structure and a lens structure. The prism structure extends in a prescribed direction and has a triangular section orthogonal to the extending direction. The lens structure extends in a prescribed direction and has a semi-circular or semi-elliptical section orthogonal to the extending direction. The prism sheet controls the advancing direction of a light beam by the prism effect or the lens effect of the plurality of optical structures formed on the base.

A backlight unit for a conventional liquid crystal display includes two prism sheets each having a prism structure. The two prism sheets are provided so that the prism structures of the prism sheets extend orthogonally to each other (see JP 10-506500 A). A general structure of such a backlight unit is shown in FIG. 14. A general structure of the prism sheet is shown in FIG. 15. Referring to FIG. 14, the backlight unit 501 includes a light source 503, a light guiding panel 504 that changes light 510 radiated from the light source 503 into a plane light source, a reflection sheet 505 provided under the light guiding panel 504 (on the opposite side to the liquid crystal panel 502), and a functional optical sheet group provided above the light guiding panel 504 (on the side of the liquid crystal panel 502). The functional optical sheet group includes a lower diffusion sheet 506, a prism sheet group 507, and an upper diffusion sheet 508.

The backlight unit 501 is a so-called edge light (side light) type illumination device provided with the light source at a side of the light guiding panel 504. The light radiated from the light source 503 comes into the side of the light guiding panel 504. The incident light is let out from the surface 504a of the light guiding panel 504. The directivity of the output light 511 from the light guiding panel 504 is consistent to some extent. More specifically, the luminance of the incident light 511 is maximized in a direction inclined at a prescribed angle with respect to the normal line to the surface 504a of the light guiding panel 504. In the description, the component of a light beam advancing in the direction in which the luminance is maximized will be referred to as the “luminance peak beam.” Note that in FIG. 14, the optical members are shown as they are separated from one another for ease of illustrating the structure of the liquid crystal display, but the optical members are placed in contact with one another in practice.

The prism group 507 includes two prism sheets 507a and 507b. As shown in FIG. 15, the prism sheets each include a sheet type base 507c and a plurality of prism shaped structures 507d arranged on the sheet type base 507c. The direction in which the prism shaped structure 507d of the prism sheet 507a extends is orthogonal to the direction in which the prism shaped structure 507d of the prism sheet 507b extends.

### DISCLOSURE OF THE INVENTION

As described above, in the conventional backlight unit, a prism sheet (optical control member) as shown in FIG. 15 is used to collect light from the light guiding panel and illuminate the liquid crystal panel effectively. The prism sheet has a high light-collecting capability. However, when a single prism sheet is used, light emitted from the prism sheet is separated in color. As a result, when an object is illuminated with an illumination device using a single prism sheet, the edge of the object shadow is colored and becomes blurry. When a single prism sheet is used in a backlight unit for a liquid crystal display, colors are likely to look different between when viewed at a certain angle and when viewed from the front.

The color separation described above will be described. FIG. 16 is a sectional view of a liquid crystal display that uses only a single prism sheet. FIG. 17 shows the state of how light is refracted within the prism sheet shown in FIG. 16. A liquid crystal display 600 shown in FIG. 16 does not use the prism sheet 507a unlike the liquid crystal display 500 shown in FIG. 14. Only the prism sheet 507b is used. The other structure is the same as that in FIG. 14. The beam 512 shown in FIG. 17 corresponds to a light beam component that advances in the direction in which the luminance of the light beam is maximized, in other words, it indicates the luminance peak beam among beams entered to the prism sheet 507b in the liquid crystal display 600.

Referring to FIG. 17, the luminance peak beam 512 entered into the prism shaped structure 507d is refracted at the surface 507e on the side of the prism shaped structure 507d in the light advancing direction and is output in the thickness-wise direction of the prism sheet 507b. The refractive index of the material that forms the prism shaped structure 507d (prism sheet 507b) differs depending on the wavelength of the light. Therefore, the amount of refraction at the surface 507e changes depending on a wavelength component included in the luminance peak beam 512. As a result, as shown in FIG. 17, the refraction direction of refraction light at the surface 507e changes depending on the wavelength. According to the above-described principle, the incident light 513 has color separation in a prescribed pattern. In FIG. 17, separation of only two wavelength components is shown for ease of illustration.

Sufficient luminance does not result using only a single prism sheet. Therefore, the conventional backlight unit uses two prism sheets placed on each other as shown in FIG. 14 in order to solve the above-described problems of color separation and insufficient luminance.

However, a group of a plurality of optical sheets (in the example shown in FIG. 14, two prism sheets and two diffusion sheets) prevent the liquid crystal display from being reduced in thickness and the cost.

The present invention was made to solve the above-described problems and it is an object of the invention to provide a liquid crystal display capable of solving the problems of color separation and insufficient luminance described above using a single optical control member.

A liquid crystal display according to the present invention includes a light source, an optical control member, and a liquid crystal display element. The optical control member is optically connected to the light source. The optical control member includes a base having optical transparency and a plurality of linear structures. The base has a light incident surface to which light from the light source is entered. The plurality of linear structures are provided on a surface of the base on an opposite side to the light incident surface. A section of the linear structure orthogonal to the extending direction includes a first sectional portion and a second sectional portion. The first sectional portion is in a triangular shape defined by first to third sides. The second sectional portion is in an approximately triangular shape having a smaller area than the first sectional portion and defined by fourth to sixth sides. The first side of said first sectional portion is abutted on and parallel to a surface of the base on the opposite side to the light incident surface. The second sectional portion is provided on the second side of the first sectional portion. The fourth side of said second sectional portion is abutted on and parallel to the second side of the first sectional portion. An angle formed between the first and second sides of said first sectional portion is smaller than an angle formed between the first and third sides. The liquid crystal display element includes a first polarizing element, a liquid crystal layer, and a second polarizing element, and they are layered on one another in this order. The first polarizing element is provided opposed to the plurality of linear structures of the optical control member. The first polarizing element is arranged in a direction to transmit a P-polarized component predominantly.

The inventors have devoted to studying about an optical control member used to control the advancing direction of incident beams. As a result, it was found that the use of the optical control member having the above-described structure allows color separation of light output from the optical control member to be reduced. A color separation pattern for light refracted at a surface of the linear structure including the fifth side of the triangular structure of the second sectional portion and a color separation pattern for light refracted at a surface of the linear structure including the sixth side of the triangular structure of the second sectional portion are reversed from each other with respect to the advancing direction of the light incident to the optical control member. Therefore, light refracted at the surface of the linear structure including the fifth side of the triangular structure of the second sectional portion and light refracted at the surface of the linear structure including the sixth side of the triangular structure of the second sectional portion cancel each other' color separation. (The principle of how color separation is reduced will be detailed later.)

Furthermore, the optical control member according to the present invention directly changes the advancing direction of a beam output from the light guiding panel with somewhat consistent directivity so that the beam advances in the thickness-wise direction of the optical control member. Therefore, it is no longer necessary to provide a lower diffusion sheet between the group of prism sheets and the light guiding panel as compared to the conventional device. More specifically, with the above-described optical control member, light with somewhat consistent directivity output from the light guiding panel using the lower diffusion sheet does not have to be converted into broad light as compared to the conventional device. Therefore, the use efficiency of light output from the light guiding panel or the like can be improved, so that the luminance characteristic can be improved. More specifically, with the above-described optical control member, the problems of color separation of output light and insufficient luminance can be solved using a single optical control member.

Furthermore, according to the present invention, the first polarizing element of the liquid crystal display element provided opposed to the plurality of linear structures is arranged in a direction to transmit a P-polarized component predominantly. As will be described, a P-polarized component is dominant in light output from the optical control member. Therefore, the first polarizing element is provided in a direction to transmit a P-polarized component predominantly, so that light output from the optical control member can be entered effectively into the liquid crystal display element. The first polarizing element is provided in a direction to transmit the P-polarized component, so that the luminance of light output from the liquid crystal display transmitted through the liquid crystal display can be increased. The effect of color separation of light output from the liquid crystal display can be improved.

In the liquid crystal display according to the present invention, each of said plurality of linear structures includes a plurality of triangular structures that define said second sectional portion. Said plurality of triangular structures are provided on the second side of the first sectional portion with no gap between one another. The number of said triangular structures is preferably from two to nine.

In this way, when the number of the triangular structures is from two to nine, the color separation can be reduced sufficiently, and the luminance characteristic can be improved. Therefore, the problems of color separation of output light and insufficient luminance described above can be solved using a single optical control member. Note that providing the plurality of triangular structures on the second side of the first sectional portion with no gap between one another means that the plurality of triangular structures are provided in contact with one another, and the plurality of triangular structures cover the entire second side.

Preferably, one of the fifth and sixth sides of the plurality of triangular shapes closer to a vertical angle opposed to the first side of said first sectional portion is shorter than the other side. In this way, among the two surfaces that define a vertical angle (such as the angle portion 12e in FIG. 1) opposed to the fourth side 12b of the second sectional portion 12a for example as shown in FIGS. 1 and 2, the light collecting surface 12f (the surface including the side 12c away from the vertical angle 11e of the first sectional portion 11a) of the linear structure 13 that refracts the luminance peak light 52 to advance in the thickness wise direction of the optical control member 1 can have a larger area. Therefore, light incident to the light collecting surface of the linear structure increases (beams to be collected increase). As a result, the use efficiency of incident light can be improved and the luminance characteristic can be even more improved.

Preferably, when a luminance peak beam that advances in a direction in which the luminance is maximized in the luminance characteristic of a beam entered into said optical control member is refracted by the above-described optical control member, the fifth and sixth sides of said triangular structure are inclined with respect to the fourth side so that the advancing direction of the luminance peak beam after being refracted by a surface of said linear structure including the fifth side of said triangular structure and the advancing direction of the luminance peak beam after being refracted by a surface of said linear structure including the sixth side of said triangular structure are reversed from each other with respect to the advancing direction of the luminance peak beam before being refracted.

Preferably, the inclination direction of the third side of said first sectional portion to the first side is approximately parallel to the direction in which the luminance is maximized in the luminance characteristic of the beam input to said optical control member. More preferably, the angle between the first and third sides of the first sectional portion (such as β₁ in FIG. 2) is equal to or greater than the angle of a luminance peak beam entered to the optical control member (such as the beam 52 in FIG. 2) with respect to the surface of the base (such as 90°−θ in FIG. 2). In this way, the reflection and refraction of incident light at the surface of the linear structure including the third side of the first sectional portion (such as the surface 13c in FIG. 1) are very much reduced, so that the use efficiency of incident light is further improved.

Preferably, the plurality of linear structures are provided periodically in a direction orthogonal to the extending direction.

Preferably, when the linear structure has a refractive index n₁, air surrounding the base and the linear structure has a refractive index no that is 1.0, an angle formed by a direction normal to an interface between the air and the base and the beam's direction in the air is I₁, an angle formed between the normal direction and the beam's direction in the linear structure is I₂, and angles formed between the first and second sides, the fourth and fifth sides, and the fourth and sixth sides are α₁, α₂, and β₂, respectively, the following expression is satisfied.

n₀ sin I₁=n₁ sin I₂

0≦sin(α₁+α₂−I₂)≦1/n₁

I₂<α₁+α₂≦I₂+90

−I₂<β₂−α₁≦90−I₂

In this way, a beam entered to the substrate and the linear structures can be extracted to the outside without being totally reflected at the light collecting surface and thus without a loss.

Preferably, when the linear structure has a refractive index n₁, a critical angle for total reflection of the beam at an interface between the base and air surrounding the linear structure is I₂ₘₐₓ, sin I₂ₘₐₓ=1/n₁ is satisfied, and angles formed between the first and second sides and the fourth and first sides are α₁ and α₂, the following expression is satisfied.

α₁+α₂≦2·I₂ₘₐₓ

In this way, an incident beam is not totally reflected at the light collecting surface of the optical control member and can be output externally from the optical control member regardless of the incident angle of the incident beam.

A liquid crystal display according to the present invention includes a light source, an optical control member, and a liquid crystal display element. The optical control member is optically connected to the light source. The optical control member includes a base having optical transparency and a plurality of linear structures. The base has a light incident surface to which light is entered. The plurality of linear structures are provided on a surface of the base on an opposite side to the light incident surface. The linear structure has optical transparency. Each of the linear structures has a plurality of other linear structures having a light collecting surface and a correction surface. A section of the linear structure orthogonal to its extending direction is approximately triangular. One of three sides defining the section of the linear structure is abutted on and parallel to a surface on an opposite side to the light incident surface of the base. One of the other two sides is stepped. The stepped side is a line intersection between the section orthogonal to the extending direction of the linear structure and the light collecting surface and the correction surface. The angle formed between a side parallel to the base and the stepped side at the section orthogonal to the extending direction of the linear structure is smaller than the angle formed between the side parallel to the base and the remaining side. The liquid crystal display element has a first polarizing element, a liquid crystal layer, and a second polarizing element provided opposed to the plurality of linear structures of said optical control member and layered on one another in this order. The first polarizing element is arranged to transmit a P-polarized component predominantly.

In this description, the term “light collecting surface” is the light output surface of the linear structure and refers to the surface that refracts an incident beam from the side of the base to advance in the thickness-wise direction of the optical control member (the thickness-wise direction of the base). The term “correction surface” is the light output surface of the linear structure and refers to the surface that refracts a beam input from the side of the base to advance in the direction of the plane of the optical control member (in the plane direction of the base). The “angle formed between the side parallel to the base and the stepped side at the section of the linear structure” is defined by the angle formed by the line intersection between the side parallel to the base and the stepped side, a straight line through the tip end of a groove portion formed by the light collecting surface and the correction surface of the linear structure, and the side parallel to the base. More specifically, the “angle formed between the side parallel to the base and the stepped side at the section of the linear structure” is defined as the smallest angle among angles formed between a straight line through the intersection of the side parallel to the base and the stepped side and intersecting the stepped side and the side parallel to the base. For example in the linear optical structure 24 whose section has a stepped side as shown in FIG. 4, the “angle formed between the side parallel to the base and the stepped side at the section of the linear structure” is α1 and the “angle formed between the side parallel to the base and the remaining side” is β1.

Preferably, the liquid crystal display according to the present invention further includes a light guiding panel that guides light from the light source to the optical control member. The light source is provided at an end of the light guiding panel.

In this way, when edge light type illumination is applied to the liquid crystal display according to the present invention, color separation of output light is controlled using a single optical control member and the luminance can be improved. Therefore, the use of two prism sheets as in the conventional device is not necessary. A lower diffusion sheet between the group of prism sheets and the light guiding panel as in the conventional device is not necessary. Therefore, when an edge light type illumination is applied to the liquid crystal display according to the present invention, the number of optical members can be reduced and the thickness and cost of the device can be reduced.

Preferably, the base has a refractive index equal to that of the linear structure. In this way, light advances straight at a joint surface (interface) between the base and linear structure. Therefore, the shape of the joint surface between the base and the linear structure can be formed into an arbitrary shape, so that the flexibility in designing can be increased. The base and the linear structure may be formed integrally using the same material.

In the liquid crystal display according to present invention, the base may have a refractive index different from that of said linear structure and may be formed to have a parallel plate shape. In this way, if the base has a refractive index different from that of the linear structure, the refraction angle of light at the interface between the base and the linear structure is the same as the refraction angle of light at the interface between the base and air when the base and the linear structure have the same refractive index. Therefore, the present invention can be applied as it is.

Preferably, the liquid crystal display according to the present invention further includes a reflection member provided on an opposite side to the optical control member of said light guiding panel.

The optical control member for use in the liquid crystal display according to the present invention includes a plurality of linear structures each having an approximately triangular section orthogonal to the extending direction and provided with a stepped portion on one side of the section. Therefore, color separation of output light can be reduced using one such optical control member. The optical control member for use in the liquid crystal display according to the present invention can directly change the advancing direction of light output from the light guiding panel and having somewhat consistent directivity to the thickness-wise direction of the optical control member. Therefore, the use efficiency of light output from the light guiding panel can be improved and the luminance characteristic can be improved. More specifically, with the above-described optical control member, color separation of output light can be reduced and the luminance characteristic can be improved using one such optical control member. Furthermore, the first polarizing element of the liquid crystal display element is arranged in a direction to transmit a P-polarized component predominantly. Therefore, the luminance of light output from the liquid crystal display through the liquid crystal display element can be improved. Furthermore, the effect of reducing color separation of light output from the liquid crystal display can be increased.

The liquid crystal display according to the invention includes the above-described optical control member, so that the problems of color separation of light and insufficient luminance can be solved while the thickness and cost of the liquid crystal display can be reduced.

### BRIEF DESCRIPTION OF THE DRAWINGS

FIG. 1 is a schematic view of an optical control sheet for use in a liquid crystal display in Inventive Example 1.

FIG. 2 is an enlarged sectional view of a linear optical structure for use in the liquid crystal display in Inventive Example 1.

FIG. 3 is a schematic view of the liquid crystal display in Inventive Example 1.

FIG. 4 is an enlarged sectional view of a linear optical structure for use in a liquid crystal display in Inventive Example 2.

FIG. 5 is a schematic view of a linear optical structure for use in liquid crystal displays in Inventive Examples 3 to 9.

FIG. 6A is an enlarged sectional view of the linear optical structure for use in the liquid crystal display in Inventive Example 1 (Inventive Example 3).

FIG. 6B is a sectional view of the linear optical structure for use in the liquid crystal display in Inventive Example 1 (Inventive Example 3).

FIG. 7A is an enlarged sectional view of the linear optical structure for use in the liquid crystal display in Inventive Example 4.

FIG. 7B is a sectional view of the linear optical structure for use in the liquid crystal display in Inventive Example 4.

FIG. 8A is an enlarged sectional view of the linear optical structure for use in the liquid crystal display in Inventive Example 5.

FIG. 8B is a sectional view of the linear optical structure for use in the liquid crystal display in Inventive Example 5.

FIG. 9A is an enlarged sectional view of the linear optical structure for use in the liquid crystal display in Inventive Example 7.

FIG. 9B is a sectional view of the linear optical structure for use in the liquid crystal display in Inventive Example 7.

FIG. 10A is a schematic sectional view of a linear optical structure when a base and the linear optical structure have the same refractive index.

FIG. 10B is a schematic sectional view of a linear optical structure when a base and the linear optical structure have different refractive indexes.

FIG. 11 is a graph showing the reflectivity intensity of light advancing from a first medium with a high refractive index to a second medium with a low refractive index with respect to an incident angle.

FIG. 12 is a graph showing a dominant polarized component of light output from a light collecting surface and a correction surface of a second linear prism portion of an optical control sheet.

FIG. 13 is a view of the arrangement of an evaluation device when luminance measurement and sensory evaluation of tints were carried out.

FIG. 14 is a schematic view of a liquid crystal display in Comparative Example 1.

FIG. 15 is a schematic view of a prism sheet in Comparative Example 1.

FIG. 16 is a schematic view of a liquid crystal display in Comparative Example 2.

FIG. 17 is a view showing color separation of output light.

### BEST MODE FOR CARRYING OUT THE INVENTION

Now, an embodiment of the present invention will be described in detail in conjunction with the accompanying drawings in which the same or corresponding to portions are designated by the same reference characters so that their description will be incorporated.

### Inventive Example 1

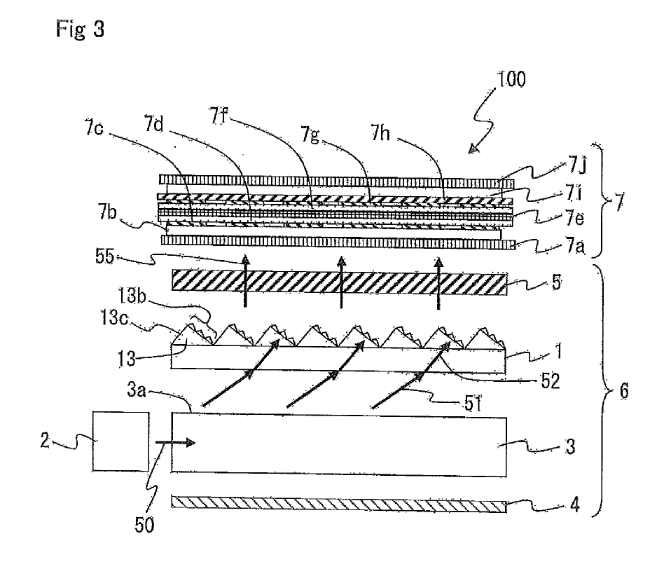

Referring to FIG. 3, a liquid crystal display device 100 according to the present invention includes a liquid crystal display panel 7 (liquid crystal display element) and a backlight unit 6 (illumination device). The backlight unit 6 includes an optical control sheet 1. To start with, the optical control sheet 1 will be described. Then, the liquid crystal display panel 7 and the back light unit 6 will be described.

Structure of Optical Control Sheet

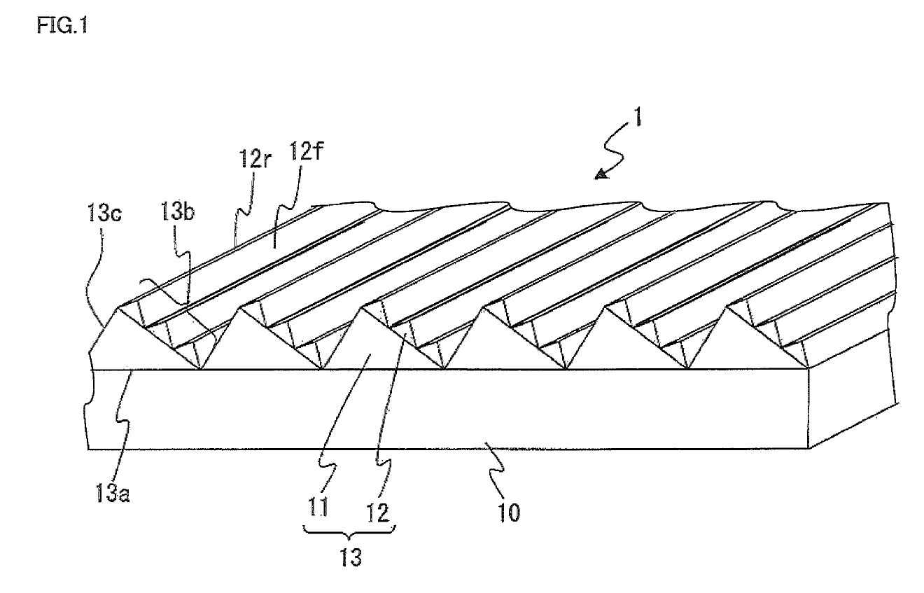

Referring to FIG. 1, the optical control sheet 1 includes a sheet-shaped, light transmitting (transparent) base 10 and a plurality of linear optical structures 13 (linear structures) formed on the base 10.

In this example, the base 10 is a polyethylene terephthalate (PET) sheet as thick as 50 μm. However, the material and the thickness of the base 10 are not limited to these. The thickness of the base 10 is preferably in the range from 10 μm to 500 μm for example in view of readiness in treating and handling the optical control sheet. Other than PET, examples of the material for the base 10 include an inorganic transparent material such as polyethylene naphthalate, polystyrene, polycarbonate (PC), polyolefin, polypropylene, cellulose acetate, and glass, and an arbitrary light transmitting material. The base 10 typically has a sheet shape as in this example. The base 10 may have a thick plate shape or another arbitrary shape. Furthermore, the surface of the base 10 does not have to be flat but a three dimensional surface.

The cross sectional shape of the linear optical structure 13 orthogonal to its extending direction is approximately triangular. The linear optical structure 13 has a bottom surface 13a and inclined surfaces 13b and 13c. The base 13a is abutted on and parallel to the surface of the base 10. In other words, the linear optical structure 13 is provided on the base 10 so that its bottom surface 13a is opposed to the surface of the base 10.

In this example, the plurality of linear optical structures 13 all have the same shape and size. The plurality of linear optical structures 13 are provided periodically in the direction orthogonal to the extending direction of the linear optical structures 13. The base angle portions of linear optical structures 13 are adjacent to one another. The interval (pitch) at which the plurality of linear optical structures 13 are provided is preferably about in the range from 7 μm to 100 μm. If the pitch is smaller 7 μm, the die for forming the linear structures 13 must have increased precision. This raises the manufacturing cost. If the pitch exceeds 100 μm, the following problem is encountered. When the pitch is larger than 100 μm, the size of the linear optical structures 13 relatively increases. The volume of resin used to form the linear optical structures 13 increases accordingly. As a result, the hardening shrinkage of resin increases when the linear optical structures 13 is formed by hardening the resin. In this case, so-called “clinging” of the resin to the die is enhanced, and the resin is not easily removed from the die. When the linear optical structures 13 are formed on the sheet base using a roll type die, in particular, some of the linear optical structures 13 are likely to be damaged or remain on the surface of the die. When the pitch is greater than 100 μm, the linear optical structures 13 have an increased height. Therefore, the optical control member will have a larger thickness.

In this example, the material of the linear optical structures 13 is ultraviolet curing resin of aromatic acrylate (with a refractive index of 1.60). Note that an arbitrary resin material having a refractive index from 1.3 to 1.9 may be used instead of the material described above for the linear optical structures 13. When the linear optical structure 13 is formed using a different material from the base 10, examples of the material include transparent plastic resin such as acrylic resin, urethane resin, styrene resin, epoxy resin, and silicone-based resin. Note that the linear optical structures 13 may be formed using the same material as that of the base 10.

The linear optical structure 13 includes a first linear prism portion 11 formed on the base 10 to extend in the same direction as the extending direction of the linear optical structure 13 and a plurality of second linear prism portions 12 formed on one surface that forms the vertical angle of the first linear prism portion 11 to extend in the same direction as the extending direction of the linear optical structure 13. As will be described, in this example, the first linear prism portion 11 and the second linear prism portions 12 are integrally formed. More specifically, in this example, the surface 13b of the linear optical structure 13 having the plurality of second linear prism portions 12 thereon is stepped (hereinafter also referred to as the “stepped surface”).

In this example, three second linear prisms 12 are formed on one surface that forms the vertical angle of the first linear prism portion 11, while the present invention is not limited to the arrangement. The number and form of the second linear prism portions 12 can be changed as required depending on a use and a necessary optical characteristic and the like. The second linear prism portions 12 may be provided both on the two surfaces that define the vertical angle of the first linear prism portion 11.

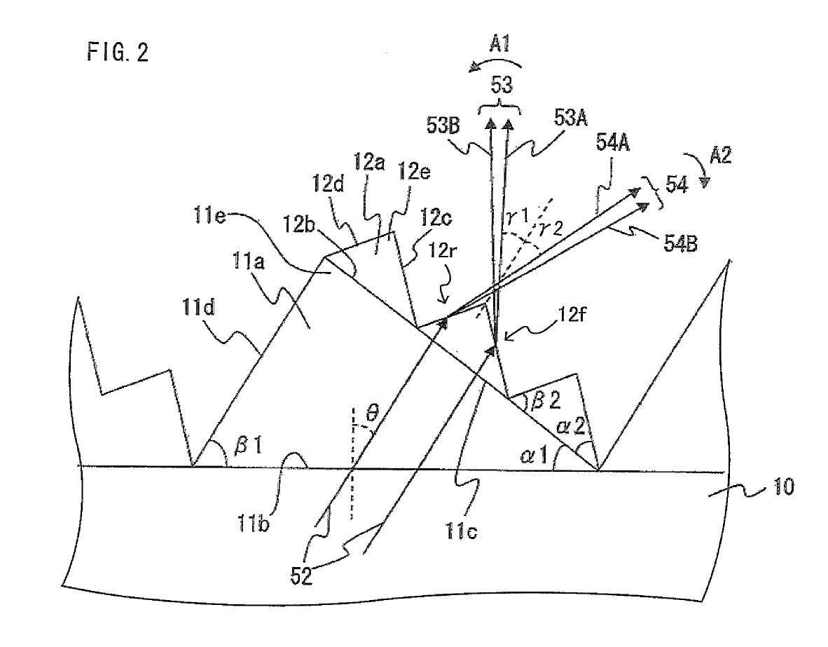

FIG. 2 is an enlarged sectional view of the linear optical structure 13. An incident beam 52 shown in FIG. 2 is a beam that advances in the direction in which the luminance is maximized in the luminance characteristic of the beam (that advances in the optical control sheet 1) entered into the optical control sheet 1. More specifically, the beam 52 is a luminance peak beam. A section of the linear optical structure 13 orthogonal to its extending direction includes a first sectional portion 11a of the first linear prism portion 11 and a second sectional portion 12a of the second linear prism portion 12.

The first sectional portion 11a has a base 11b (first side), an inclined side 11c (second side), and an inclined side 11d (third side). The base 11b is abutted on and parallel to the surface of the base 10. The inclined sides 11c and 11d extend at prescribed angles (α1 and β1 in FIG. 2), respectively from both ends of the base 11b. In this example, among the two inclined sides 11c and 11d that define the vertical angle 11e opposed to the bottom surface 11b, the inclined side 11c (second side) in contact with the second sectional portion 12a has a greater length than the length of the other inclined side 11d (third side). Therefore, the first base angle α₁ between the base 11b and the inclined side 11c is smaller than the second base angle β₁ between the bases 11b and the inclined side 11d. More specifically, in this example, the shape of the first sectional portion 11a is an asymmetric triangle (not an isosceles triangle).

In this example, the inclination angle of the inclined side 11d from the normal direction to the surface of the base 10 is approximately equal to the inclination angle of the advancing direction of the luminance peak beam 52 (θ in FIG. 2) from the normal direction to the surface of the base. More specifically, the inclination direction of the surface 13c of the linear optical structure 13 including the inclined side 11d (hereinafter also referred to as the “flat surface”) is approximately parallel to the advancing direction of the luminance peak beams 52. More specifically, as will be described, the inclination angle (β₁ in FIG. 2) of the flat surface 13c with respect to the surface of the base is slightly larger than the inclination angle (90°−θ) of the luminance peak beam 52 in the linear optical structure 13 from the surface of the base.

The specific size of the first sectional portion 11a in this example is as follows. The length of the base 11b of the first sectional portion 11a is 35 μm. The first base angle α₁ of the first sectional portion 11a is 39.14°. The second base angle β₁ is 57.71°.

The second portion 12a has a base 12b (fourth side), an inclined side 12c (fifth side), and an inclined side 12d (sixth side). The base 12b is abutted on and parallel to the inclined side 11c (second side). The inclined sides 12c and 12d extend at prescribed angles (α₂ and β₂ in FIG. 2), respectively from both ends of the base 12b. In this example, as shown in FIG. 2, among the two inclined sides 12c and 12d, the length of the inclined side 12d closer to the vertical angle 11e is shorter than the other inclined side 12c. Therefore, the first base angle α₂ between the base 12b and the inclined side 12c is smaller than the second base angle β₂ between the base 12b and the inclined side 12d. In this example, the shape of the second sectional portion 12a is an asymmetric triangle (not an isosceles triangle).

As will be described, the surface 12f of the second linear prism portion 12 including the inclined side 12c (fifth side) mainly refracts an incident beam in the advancing direction to advance in the thickness-wise direction of the optical control sheet 1. The surface 12f is capable of collecting incident beams. Therefore, the surface 12f will be hereinafter referred to as the “light collecting surface 12f.” On the other hand, as will be described, the surface 12r of the second linear prism portion 12 including the inclined side 12d (sixth side) mainly controls color separation of light output from the optical control sheet 1. Therefore, the surface 12r will be hereinafter referred to as the “correction surface 12r.”

When the length of the inclined side 12c positioned away from the vertical angle 11e is larger than the length of the other inclined side 12d, the light collecting surface 12f can be widened. In this way, the use efficiency of incident light improves.

In this example, as shown in FIG. 2, the first base angle α₂ and the second base angle β₂ of the second sectional portion 12a are set so that the direction of a beam 53 resulting from refraction at the light collecting surface 12f and the direction of a beam 54 resulting from refraction at the correction surface 12r of the second linear prism portion 12 as the incident luminance peak beam 52 leaves the optical control sheet 1 are reversed from each other with respect to the advancing direction of the luminance peak beam 52 before being refracted. According to the present embodiment, the first base angle α₂ and the second base angle β₂ are set so that the angle γ1 between the refraction direction of a prescribed wavelength component of the bream 53 (such as a wavelength A component 53A in FIG. 2) and the advancing direction of the luminance peak beam 52 and the angle γ2 between the refraction direction of a prescribed wavelength component of the beam 54 (such as a wavelength A component 54A in FIG. 2) and the advancing direction of the luminance peak beam 52 are approximately equal. In this way, color separation of light output from the optical control sheet 1 can be even more reduced.

Note that as far as the color separation of light output from the optical control sheet 1 can be reduced sufficiently, the angles γ1 and γ2 may be different.

The specific size of the second sectional portion 12a is as follows. The length of the base 12b of the second sectional portion 12a is about 10.44 μm. The first base angle α₂ of the second sectional portion 12a is 30°. The second base angle β₂ of the second sectional portion 12a is 70°.

In this example, the three second linear prism portions 12 have the same shape and size. The three second linear prism portions 12 are provided periodically in the direction orthogonal to their extending direction. The base angle portions of adjacent second linear prism portions 12 are in contact with each other. More specifically, in this example, the light collecting surfaces 12f and the correction surfaces 12r of the second linear prism portions 12 that form the stepped surface 13b of the linear optical structure 13 are arranged parallel to one another and at equal intervals.

Method of Manufacturing Optical Control Sheet

A method of manufacturing the optical control sheet 1 is as follows. To start with, a roll type die is prepared. An irregularity pattern corresponding to the shape of the plurality of linear optical structures 13 shown in FIG. 1 is formed by cutting on the surface of the roll die. Then, ultraviolet curing resin is filled between the prepared base 10 and the die surface. Irradiation of a ultraviolet beam with a wavelength of 340 nm to 420 nm cures the filled ultraviolet curing resin. After the ultraviolet curing resin is cured, the base 10 is separated from the base 10. In this way, the optical control sheet 1 is obtained.

The method of manufacturing the optical control sheet is not limited to the above-described method and other known arbitrary methods can be used. For example, thermosetting resin is used to produce a base. Then, a die provided with an irregularity pattern corresponding to the shape of the plurality of linear optical structures 13 by cutting is thermally pressed against the produced base. At the time, the irregularity pattern of the die is transferred onto the surface of the base. The thermal transfer method may be employed to directly form the optical structures on the base. Alternatively, the plurality of linear optical structures 13 may be formed on the base by a well-known method such as extrusion molding, press molding, and injection molding by which fused resin is injected into a die. In this case, the base 10 and the linear optical structures 13 are formed using the same material.

Liquid Crystal Display Panel

The structure of a liquid crystal display panel will be described. In FIG. 3, for the ease of illustrating the structure of the liquid crystal display, optical members are shown as they are separated from one another. In an actual device, the optical elements are layered in contact with one another.

As shown in FIG. 3, the liquid crystal display panel 7 includes a first polarizing plate 7a, a glass substrate 7b, a first transparent conductive film 7c that forms a pixel electrode, a first alignment film 7d, a liquid crystal layer 7e, a second alignment film 7f, a transparent conductive film 7g that firms a counter electrode, a color filter 7h, a glass substrate 7i, and a second polarizing plate 7j. These elements are placed on one another in the mentioned order from the side of the backlight unit 6. On the side closer to the optical control sheet 1, the first polarizing plate 7a is provided. Light output from the optical control sheet 1 comes into the liquid crystal display panel 7 from the side of the first polarizing plate 7a.

In the liquid crystal display panel 7, the first polarizing plate 7a is arranged in a direction to transmit P-polarized light predominantly. The second polarizing plate 7j is arranged in the direction to transmit S-polarized light predominantly. The reason why the two polarizing plates 7a and 7j are arranged in this manner will be described in the following.

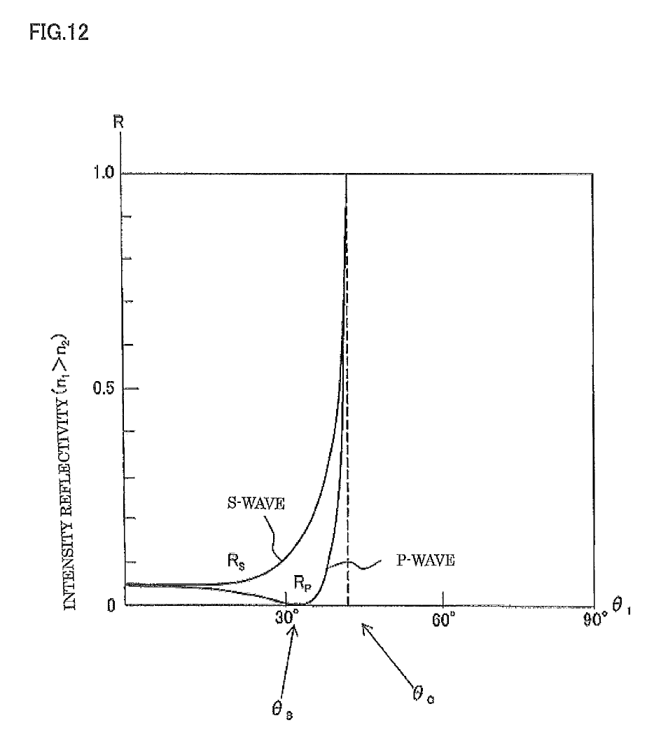

The light collecting surface 12f of the second linear prism portion 12 of the optical control sheet 1 and the like are provided so that light can be output to the outside without totally reflecting an incident luminance peak beam. It is known that a part of light passed through these surfaces is reflected even without total reflection in this way. This is called Fresnel reflection. The magnitude of Fresnel reflection depends on the difference between refractive indexes at an interface, the incident angle of light coming into the interface, and the polarization direction of light. FIG. 12 (from HADOU KOGAKU ENGINEERING NO KISO (basics about wave optics engineering), page 47 published by Optronics Co., Ltd.) shows the intensity of reflectivity of light advancing from a first medium with a high refractive index (n1=1.5) to a second medium with a low refractive index (n2=1.0) with respect to the incident angle. In FIG. 12, Rp indicates the reflectivity with respect to a P-polarized component, Rs indicates the reflectivity with respect to an S-polarized component, and θc indicates a critical angle for total reflection. As can be seen from the graph in FIG. 12, at each of incident angles (formed between a line normal to the interface and the advancing direction of light) that is smaller than the critical angle θc, the light is not entirely transmitted through the interface, but part of the light is reflected at the interface. The reflectivity Rs of the S-polarized component is generally higher than the reflectivity Rp of the P-polarized component. Note that there is a so-called Brewster angle θB at which the reflectivity Rp is zero with respect to the P-polarized component. In this description, the P-polarized component and the S-polarized component are defined as follows. A plane of incidence is defined by the advancing direction of a luminance peak beam and the normal line to the base of the optical control sheet. The component whose electric field vector oscillates parallel to the plane of incidence is defined as the P-polarized component. The component whose electric field vector oscillates orthogonally to the plane of incidence is defined as the S-polarized component.

As described above, light that advances from the first medium with a high reflectivity to the second medium with a low reflectivity is partly reflected at the interface between these media even its angle of incidence is not more than the critical angle for total reflection. In this case, the reflectivity is different between the P-polarized component and the S-polarized component. As shown in FIG. 12, the reflectivity Rs of the S-polarized component is generally higher than the reflectivity Rp of the P-polarized component. Therefore, at the interface, the S-polarized component is reflected more than the P-polarized component at the interface. More specifically, the P-polarized component of the light is predominantly transmitted through the interface.

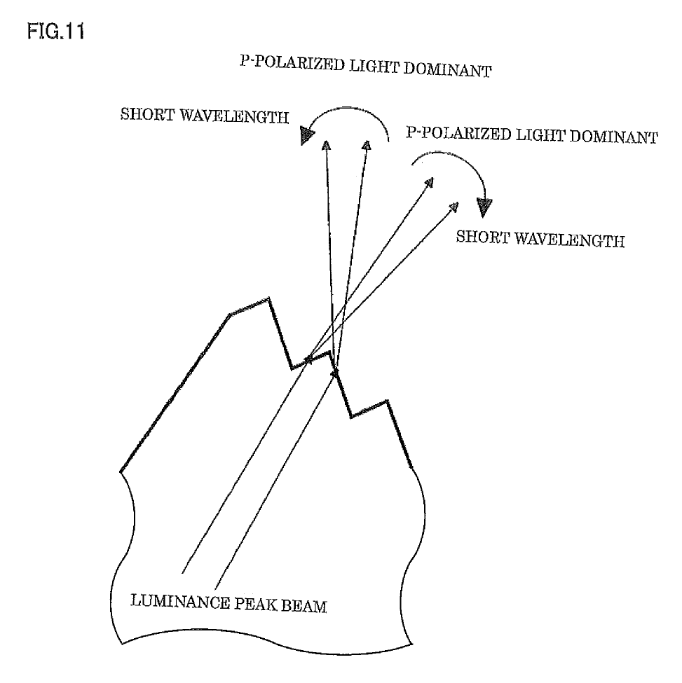

As shown in FIG. 11, as for light output from the light collecting surface 12f and the correction surface 12r of the second linear prism portion 12 of the optical control sheet 1, the P-polarized component is dominant. The direction of color separation of a beam passed through the light collecting surface 12f is reversed from the direction of color separation of a beam passed through the correction surface 12r. Therefore, the second linear prism portion 12 greatly reduces the color separation.

As described above, the P-polarized component of light is predominantly output from any of the light collecting surface 12f and the light collecting surface 12r. Therefore, the first polarizing plate 7a of the liquid crystal display panel 7 provided opposed to the light collecting surface 12f and the correction surface 12r of the second linear prism portion 12 is preferably provided in a direction to transmit the P-polarized component. In this arrangement, light predominantly output from the light collecting surface 12f and the correction surface 12r can be used effectively.

Stated differently, the first polarizing plate 7a of the liquid crystal display panel 7 is provided to transmit the P-polarized component of light output from the light collecting surface 12f and the correction surface 12r. In this way, the luminance of light transmitted through the liquid crystal display panel 7 can be increased as compared to the case in which the first polarizing plate 7a is provided to transmit the S-polarized component of light. Furthermore, the color separation is further reduced. Note that in the following description, the direction of the first polarizing plate 7a (provided on the side of the optical control member) and the direction of the second polarizing plate 7j (provided on the opposite side to the optical control member) are orthogonal to each other. More specifically, when the first polarizing plate 7a is arranged in a direction to transmit the P-polarized component, the second polarizing plate 7j is arranged in a direction to transmit the S-polarized component. Conversely, when the first polarizing plate 7a is arranged in a direction to transmit the S-polarized component, the second polarizing plate 7j is arranged in a direction to transmit the P-polarized component.

Backlight Unit

Referring to FIG. 3, the backlight unit 6 includes a light source (LED: Light Emitting Diode) 2, a light guiding panel 3, a reflection sheet 4 (reflection member), an optical control sheet 1, and a diffusion sheet 5. The light guiding panel 3 outputs a beam 50 coming into the side from an upper surface 3a (output surface). The reflection sheet 4 is provided under the light guiding panel 3 (on the opposite side to the liquid crystal display panel 7). The optical control sheet 1 is provided on the light guiding panel 3 (on the side of the liquid crystal display panel 7). The diffusion sheet 5 is provided on the optical control sheet 1. The light source 2 radiates white light in the visible light range. The backlight unit 6 is an edge light type illumination device and therefore the light source 2 is provided on the side of the light guiding panel 3. A beam output from the light source 2 comes into the light guiding panel 3 from its side. The beam advances in the direction of light 50 in the light guiding panel 3. Then, it is output from the output surface 3a. The output light 51 has the above-described directivity.

The optical control sheet 1 is laid so that the stepped surface 13b of the linear optical structure 13 serves as a main receiving surface for the inclined incident beam 52. Stated differently, the optical control sheet 1 is laid so that the stepped surface 13b among the two surfaces 13b and 13c of the linear optical structures 13 is further from the light source 2.

The optical members other than the optical control sheet 1 are the same as those of a conventional backlight unit. More specifically, the light guiding panel 3 in this example is formed using polycarbonate. The light guiding panel 3 has such an output characteristic that the angle formed between the advancing direction of the luminance peak beam and the normal direction to the output surface 3a is 70°. The light 51 output from the output surface 3a is entered into the optical control sheet 1 and then refracted at the lower surface of the base 10. As will be described, when the base and the linear structure have different refractive indexes, the light 51 is refracted at the interface between the base and the linear structure. The inclination angle θ formed between the advancing direction of the luminance peak beam 52 in the linear optical structure 13 and the normal line to the surface of the base 10 (the thickness-wise direction of the optical control sheet 1) is about 36°. More specifically, the inclination angle θ is slightly greater than the angle)(90°−β₁=32.29° formed between the inclination angle (the base angle β₁) of the flat surface 13c and the normal line to the surface of the base 10.

A sheet produced by vapor-depositing silver on the surface of a PET film is used for the reflection sheet 4. A bead-coated PET film is used for the diffusion sheet 5 and has a thickness of 70 μm and a haze of 30%.

Principle of How Color Separation is Reduced

The principle of how the optical control sheet 1 reduces color separation of an output beam will be described with reference to FIGS. 1 to 3.

When the output light 51 enters the optical control sheet 1, the incident beam is mainly refracted by the stepped surface 13b, in other words, the second linear prism portion 12. The direction in which the flat surface 13c of the linear optical structure 13 is inclined is approximately parallel to the advancing direction of the luminance peak beam 52 as described above. Therefore, the incident beam is not easily entered into the flat surface 13c.

The luminance peak beam 52 entered into the stepped surface 13b is refracted by two surfaces that define each raised surface (the surface of the stepped portion) of the stepped surface 13b, in other words by the light collecting surface 12f and the correction surface 12r. As shown in FIG. 2, at the time, the luminance peak beam 52 is refracted at the light collecting surface 12f in the thickness-wise direction of the optical control sheet 1 (the normal direction to the surface of the base 10) (the beam 53 in FIG. 2). On the other hand, the luminance peak beam 52 is refracted in the in-plane direction of the optical control sheet 1 (the in-plane direction of the base 10) at the correction surface 12r (the beam 54 in FIG. 2). Therefore, the advancing direction of the beam 53 refracted by the correction surface 12f and the advancing direction of the beam 54 refracted by the correction surface 12r are reversed from each other with respect to the advancing direction of the luminance peak beam 52 before the refraction.

The refractive index of the material that forms the linear optical structure 13 is different depending on the wavelength of incident light. Therefore, when the luminance peak beam 52 is refracted by the stepped surface 13b, the refraction angle is different depending on the wavelength components included in the luminance peak beam 52. As a result, color separation is generated in the refracted beams 53 and 54 as shown in FIG. 2. In FIG. 2, for ease of description, only separation into two wavelength components (wavelengths A and B where A>B) is shown. Beams 53A and 54A shown in FIG. 2 represent the wavelength A components of the refracted beams. Beams 53B and 54B represent wavelength B components of the refracted beams. In FIG. 2, the wavelength B component is refracted more greatly than the wavelength A component (the greater refraction angle).

As shown in FIG. 2, when the luminance peak beam 52 is refracted by the light collecting surface 12f, the wavelength B component 53B of the refracted beam 53 is refracted more greatly than the wavelength A component 53A. Therefore, the advancing (refraction) direction of the wavelength B component 53B is directed toward the arrow A1 in FIG. 2 (toward the normal direction to the optical control sheet 1). On the other hand, when the luminance peak beam 52 is refracted at the correction surface 12r, the wavelength B component 54B of the refracted beam 54 is refracted more greatly than the wavelength A component 54A. Therefore, the advancing direction of the wavelength B component 54B is directed further toward the arrow A2 in FIG. 2 (the direction away from the normal to the optical control sheet 1) than the wavelength A component 54A. More specifically, the color (wavelength) separation pattern of the beam 53 is reversed from the color (wavelength) separation pattern of the beam 54 are reversed from each other with respect to the advancing direction of the luminance peak beam 52. Therefore, the color separation of the beam 53 is cancelled by the color separation of the beam 54. Consequently, the color separation of light collected at the liquid crystal display plane is reduced.

The use of a single optical control sheet 1 can reduce the color separation of the output light. Therefore, the conventional two prism sheets are no longer necessary when the optical control sheet 1 is used for a backlight unit. The optical control sheet 1 directly changes the advancing direction of the beam 51 output from the light guiding panel 3 to the normal direction to the optical control sheet 1. Therefore, unlike the conventional technique, no lower diffusion sheet is necessary between the prism sheet group and the light guiding panel. The lower diffusion sheet converts the output beam 51 from the light guiding panel 3 into board light first, and therefore the use efficiency of light is reduced. When the lower diffusion sheet is not used, the use efficiency of light output from the light guiding panel 3 improves, which improves the luminance characteristic.

As in the foregoing, the liquid crystal display 100 can reduce the color separation of output light. The two prism sheets are not necessary and there is no necessity for using the lower diffusion sheet. Therefore, in the liquid crystal display 100, the number of optical elements is smaller than the conventional device, and as a result, the size and the cost of the liquid crystal display 100 can be reduced.

Evaluation of Optical Characteristics

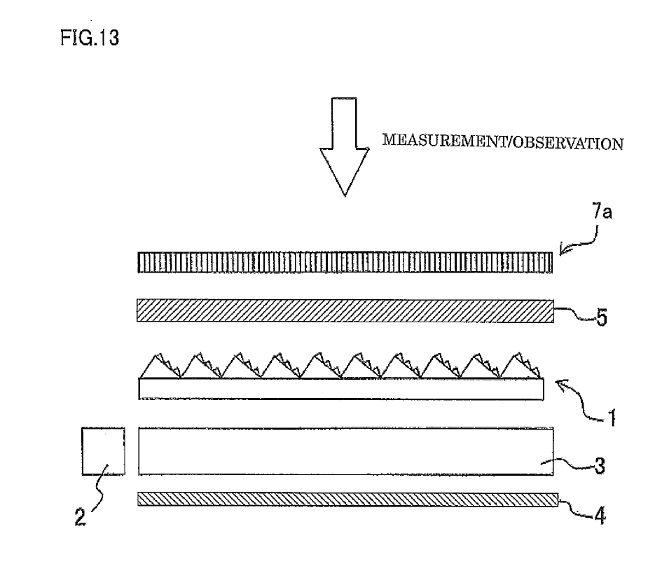

Optical characteristics of the liquid crystal display 100 in Inventive Example 1 were evaluated. More specifically, the front luminance was measured and sensory evaluation of tints was carried out. To start with, an evaluation device corresponding to the liquid crystal display according to Inventive Example 1 shown in FIG. 13 was produced. The evaluation device according to Inventive Example 1 includes a light source 2, a light guiding panel 3, an optical control sheet 1, a reflection plate 4, a diffusion sheet 5, and a first polarizing plate 7a. Light transmitted through the first polarizing plate 7a becomes a beam directly entered to the liquid crystal layer, and therefore the optical characteristics of the transmitted light through the first polarizing plate 7a were evaluated using the evaluation device. More specifically, in the evaluation device corresponding to the liquid crystal display 100 according to Inventive Example 100, the polarizing plate was arranged in a direction to transmit a P-polarized component. Using a luminance meter, the front luminance of the transmitted light was measured. Sensory evaluation of tints was carried out by visual inspection. More specifically, the tint of output light from the evaluation device was observed by visual inspection from the front. In this way, the color homogeneity of the output light was examined.

An evaluation device as Comparative Example 8 was produced. The evaluation device according to Comparative Example 8 had a second polarizing plate 7j disposed on the diffusion sheet 5 instead of the first polarizing plate 7a. More specifically, the polarizing plate was arranged in a direction to transmit an S-polarized component. The other structure was the same as that of the evaluation device according to Inventive Example 1. As for the evaluation device according to Comparative Example 8, the front luminance and the tint of output light were examined.

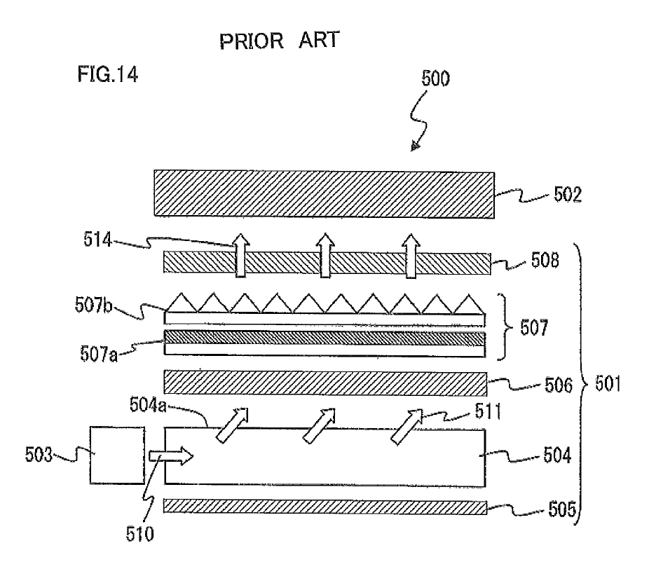

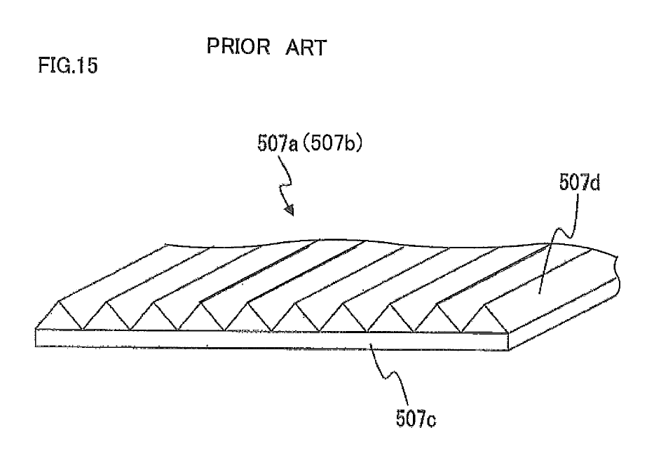

As Comparative Example 1, a conventional liquid crystal display 500 shown in FIG. 14 was also subjected to the same evaluation process. More specifically, an evaluation device corresponding to the liquid crystal display 500 according to Comparative Example 1 was prepared as follows. As compared to the evaluation device according to Inventive Example 1, prism sheets 507a and 507b and a lower diffusion sheet 506 were provided in place of the optical control sheet 1. The lower diffusion sheet 506 is laid on the light guiding panel 3. The prism sheet 507a was laid on the lower diffusion sheet 506, and the prism sheet 507b was laid on the prism sheet 507a. The prism sheets 507a and 507b were arranged with respect to the light source 2 in the same manner as that in FIG. 14. The prism shaped structures of the prism sheets 507a and 507b each had an isosceles triangle shape in cross section. The isosceles triangle had a width of 30 μm and a height of 15 μm. The vertical angle was 90°. The base 507c was a PET film and the prism shaped structures 507d were formed using UV-curing acrylic resin. A PET film coated with beads was used for the lower diffusion sheet 506. The lower diffusion sheet 506 had a thickness of 70 μm and a haze of 85%. The optical members other than the prism sheet group 507 (507a and 507b) and the lower diffusion sheet 506 were the same as those of the evaluation device according to Inventive Example 1. Therefore, the polarizing plate of the evaluation device according to the Comparative Example 1 was arranged in a direction to transmit a P-polarized component of light. Using the evaluation device according to Comparative Example 1, the front luminance of a beam transmitted through the polarizing plate 7a was measured and sensory evaluation of tints was carried out.

An evaluation device according to Comparative Example 4 having the following structure was produced. A polarizing plate 7j was laid on the diffusion sheet 5 instead of the polarizing plate 7a. More specifically, the polarizing plate was arranged in a direction to transmit an S-polarized component. The other structure was the same as that of the evaluation device according to Comparative Example 1. As for the evaluation device according to Comparative Example 4, the front luminance and the tint of output light were examined.

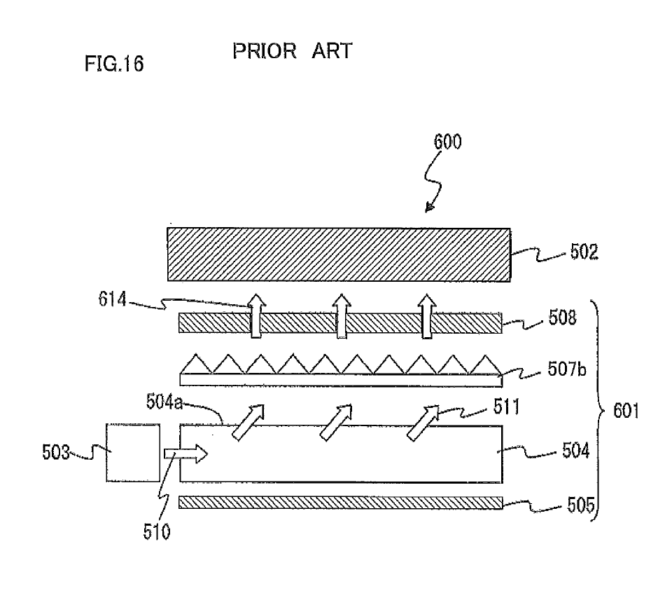

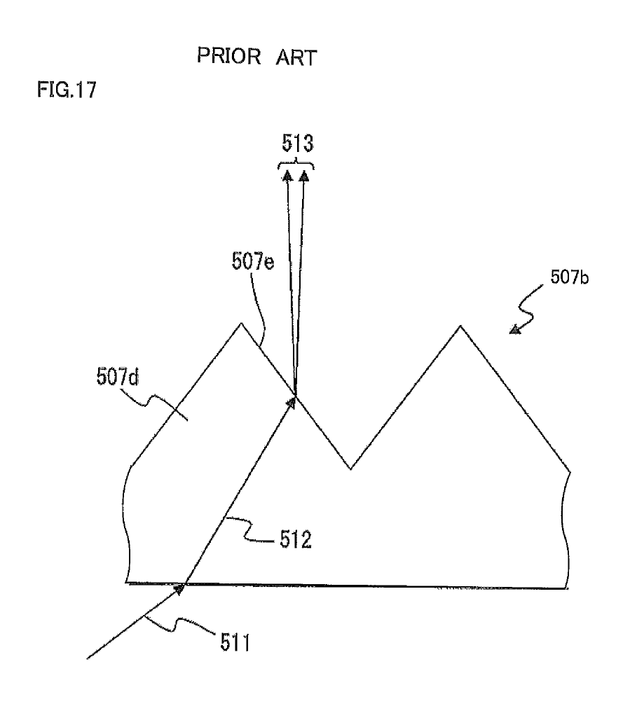

The liquid crystal display 600 having the structure as shown in FIG. 16 was subjected to the above described process. More specifically, an evaluation device according to Comparative Example 2 corresponding to the liquid crystal display 600 was produced. As compared to the evaluation device according to Inventive Embodiment 1, a single conventional prism sheet 507b was laid in place of the optical control sheet 1 in the evaluation device according to Comparative Example 2. The other structure was the same as that of the evaluation device according to Inventive Example 1. The polarizing plate of the evaluation device according to Comparative Example 2 was arranged to transmit a P-polarized component.

Furthermore, an evaluation device according to Comparative Example 5 was produced. As compared to the evaluation device according to Comparative Example 2, a polarizing plate 7j was layered instead of the polarizing plate 7a in the evaluation device according to Comparative Example 5. More specifically, in place of the polarizing plate that transmits a P-polarized component, the polarizing plate that transmits an S-polarized component was placed. The other structure was the same as that of the evaluation device according to Comparative Example 2.

The results of the above-described evaluation were given in the following Table 1. Table 1 includes the number of optical sheets provided between the light guiding panel and the polarizing plate for the liquid crystal display panel. The front luminance was represented as a luminance ratio (%) with respect to the front luminance of Comparative Example 4 that will be described as a reference (100%). The criterion for color homogeneity evaluation results ⊚ and X in Table 1 are as follows.

⊚: The tint of output light from an evaluation device is white that is the same as output light from a light source. The difference in tint between the output light from the evaluation device and the output light from the light source cannot be recognized by visual inspection.

∘: While the difference in tint between the output light from the evaluation device and the output light from the light source can be recognized by visual inspection, the difference is not as noticeable as in the case of “x.”

x: Output light 55 from an evaluation device has a tint of color such as red and yellow, and the tint is in a visually recognizable level.

In addition to the evaluation results of Inventive Example 1 and Comparative Examples 1, 2, 4, 5, and 8, the evaluation results of Inventive Example 2 and Comparative Example 3 were also given in Table 1.

TABLE 1

| | Direction | Front | | Color | Number |
|---|---|---|---|---|---|
| | of | luminance | | homogeneity | of |
| | polarizing | (through | | (through | optical |
| | plate | polarizing plate) | | polarizing plate | sheets |
| Inventive | P | 128% | ⊚ | ⊚ | 2 |
| Example 1 | | | | | |
| Comparative | S | 107% | ◯ | ◯ | 2 |
| Example 8 | | | | | |
| Inventive | P | 134% | ⊚ | ⊚ | 2 |
| Example 2 | | | | | |
| Comparative | S | 112% | ◯ | ◯ | 2 |
| Example 3 | | | | | |
| Comparative | P | 108% | ◯ | ◯ | 4 |
| Example 1 | | | | | |
| Comparative | S | 100% | ◯ | ◯ | 4 |
| Example 4 | | | | | |
| Comparative | P | 88% | X | X | 2 |
| Example 2 | | | | | |
| Comparative | S | 73% | X | X | 2 |
| Example 5 | | | | | |

As can be clearly understood from Table 1, in the liquid crystal display according to Inventive Example 1, the front luminance was improved as compared to the liquid crystal display according to Comparative Example 1 (FIG. 14) and the number of optical sheets was reduced. More specifically, it was found that the thickness and the cost of the liquid crystal display according to Inventive Example 1 can be reduced while the optical characteristics can be improved. With the liquid crystal display according to Inventive Example 1, the front luminance and the color homogeneity were both improved as compared to the liquid crystal display (FIG. 16) according to Comparative Example 2.

In Comparative Example 8, an S-polarized component of light was arranged to be transmitted. Therefore, the front luminance was lower than that of Comparative Example 1. The effect of reducing color separation was lower than that of Inventive Example 1.

In the above description of the optical control sheet according to Inventive Example 1, the plurality of second prism structures all had the same shape and size. However, the optical control sheet used according to the present invention is not limited to this arrangement. The plurality of second prism structures may have similar shapes. In this case, the light collecting surfaces and the correction surfaces of the plurality of second prism structures are parallel to one another. Therefore, the same effect as that of Inventive Example 1 can be provided.

In the liquid crystal display 100 according to Inventive Example 1 described above, the diffusion sheet 5 was laid on the optical control sheet 1. The diffusion sheet 5 further improves luminance variations in output light from the optical control sheet 1 and further improves the display quality. However, the present invention is not limited to this. For example, when the quality of output light from the optical control sheet is sufficiently good (when variations in luminance or the like is reduced as much as possible) or when the invention is applied to a use which does not require high quality display performance, the diffusion sheet 5 is not necessary.

In the liquid crystal display 100 used in Inventive Example 1, the reflection sheet 4 was provided on the opposite side to the optical control sheet 1 of the light guiding panel 3. However, the invention is not limited to this. For example, when the surface of the light guiding panel 3 on the opposite side to the side of the optical control sheet 1 has a structure (such as a structure with irregularities) that allows a sufficient reflection effect to be obtained, the reflection sheet 4 is not necessary.

The size of the optical control sheet 1 is not limited to the size of the optical control sheet in Inventive Example 1 described above.

### Inventive Example 2

The optical control sheet according to the present invention can have its optical characteristics such as the luminance and color scattering of output light balanced by adjusting the number of the second linear prism portions that form the stepped surface of the linear optical structure and the positions and area ratio of the light collecting surface and the correction surface at the stepped surface or if necessary the inclination angles of the light collecting surface and the correction surface.

In the optical control sheet for use in a liquid crystal display according to Inventive Example 2, the number, the shape and the size of the second linear prism portions are different from those of Inventive Example 1 so that the number of beams entering the light collecting surface is relatively greater than the correction surface. The other structure has the same structure and material as those of Inventive Example 1. In the liquid crystal display according to Inventive Example 2, the structure other than the optical control sheet is the same as that of the liquid crystal display according to Inventive Example 1.

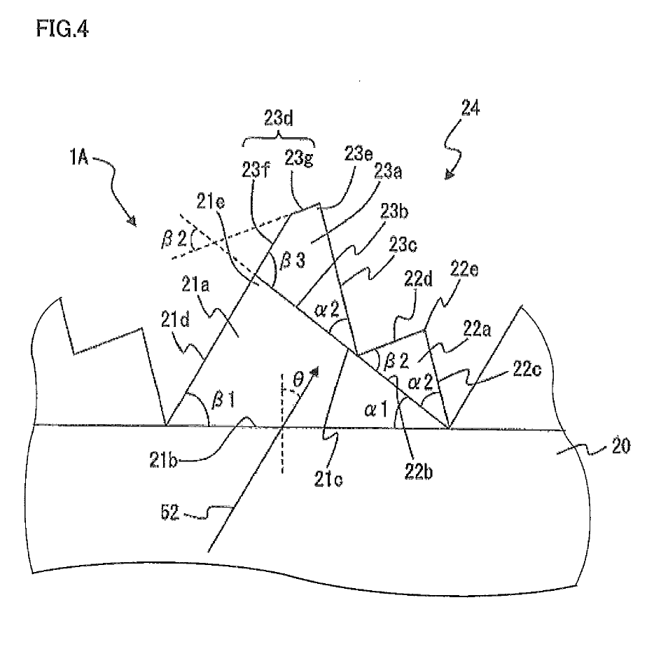

FIG. 4 is an enlarged sectional view of the linear optical structure of the optical control sheet for use in the liquid crystal display according to Inventive Example 2. The linear optical structure 24 in this example has an approximately triangular section that is orthogonal to its extending direction. The bottom surface (the surface including a base 21b) along the extending direction is abutted on and parallel to the surface of the base 20. More specifically, the linear optical structure 24 is provided on the base 20 so that its bottom surface is opposed to the surface of the base 20. Note that an incident beam 52 shown in FIG. 4 is a luminance peak beam.

As shown in FIG. 4, the section of the linear optical structure 24 orthogonal to the extending direction of the structure includes a first sectional portion 21a and two second sectional portions 22a and 23a in different shapes provided on one side of the first sectional portion 21a. More specifically, in this example, the two second linear prism portions in different shapes (the linear structures corresponding to the second sectional portions 22a and 23a) are provided on one surface of the first linear prism portion of the linear optical structure 24 (the linear structure corresponding to the first sectional portion 21a). The two second sectional portions 22a and 23a are provided to have their base angle portions contacted with each other.

The first sectional portion 21a is defined by a base 21b (first side) and inclined sides 21c (second side) and 21d (third side). The base 21b is abutted on and parallel to the base 20. The base 21b is abutted on and parallel to the surface of the base 20. The inclined sides 21c and 21d extend at prescribed angles (base angles α₁ and β₁ in FIG. 4), respectively from both ends of the base 21b. In the optical control sheet in this example, the shape of the first sectional portion 21a (the shape of the first linear prism portion) is the same as that of Inventive Example 1. More specifically, the base angles α₁ and β₁ are 39.14° and 57.71°, respectively. The length of the base 21b is 35 μm.

The relation between the inclination angle (90−β₁) of the inclined side 21d with respect to the normal direction to the surface of the base 20 and the inclination angle θ of the advancing direction of the luminance peak beam 52 with respect to the normal direction to the surface of the base 20 is the same as that in Inventive Example 1. More specifically, the inclination direction of the surface (flat surface) of the linear optical structure 24 including the inclined side 21d is approximately parallel to the advancing direction of the luminance peak beam 52. More specifically, the base angle β₁ is slightly greater than the inclination angle of the luminance peak beam 52 in the linear optical structure 24 with respect to the surface of the base 20 (90°−θ).

The second sectional portion 22a is positioned on the side of the first base angle α₁ of the first sectional portion 21a. The second sectional portion 22a has a triangular shape. The second sectional portion 22a has a base 22b (fourth side), an inclined side 22c (fifth side), and an inclined side 22d (sixth side). The base 22b is abutted on and parallel to the inclined side 21c (second side). The inclined sides 22c and 22d extend at prescribed angles (base angles α₂ and β₂ in FIG. 4), respectively from both ends of the base 22b. The shape of the second sectional portion 22a is similar to that of the second sectional portion 12a in Inventive Example 1. The first and second base angles α₂ and β₂ of the second sectional portion 22a are 30° and 70°, respectively. The base 22b is about 14.92 μm, which is longer than the base 12b (about as long as 10.44 μm) of the second sectional portion 12a in Inventive Example 1. More specifically, the area of the second sectional portion 22a is larger than the area of the second sectional portion 12a in Inventive Example 1.

The surface of the second linear prism portion including the inclined side 22c is a light collecting surface. An incident beam is refracted by the light collecting surface to advance in the thickness-wise direction of the optical control sheet. More specifically, the light collecting surface serves to focus incident light. On the other hand, the surface of the linear optical structure 24 including the other inclined side 22d of the second sectional portion 22a is a correction surface. The correction surface serves to reduce color separation of light output from the optical control sheet. In this example, the area of the light collecting surface of the second linear prism portion positioned on the side of the first linear prism portion closest to the base angle (on the α₁ side in FIG. 4) is greater than that of Inventive Example 1.

When the light collecting surface of the second linear prism portion positioned on the side of the first linear prism portion closest to the base angle (on the α₁ side in FIG. 4) has a larger area, the use efficiency of incident light improves. This improves the luminance. This is for the following reason.

When the surface of the first linear prism portion having the second linear prism portion (the surface including the second side 21c in FIG. 4) will be hereinafter referred to as the “second linear prism portion forming surface.” A beam transmitted through the second linear prism portion forming surface, in other words, a beam entering the stepped surface of the optical control sheet includes a beam component other than the luminance peak beam 52. Therefore, the intensity (illuminance) of a beam transmitted through the second linear prism portion forming surface varies depending on through which part of the second linear prism portion forming surface the beam is transmitted. More specifically, the intensity of the beam transmitted through the second linear prism portion forming surface increases toward the side of the base angle α₁ of the first linear prism portion. More specifically, as the beam enters the second linear prism portion more on the side of the base angle of the first linear prism portion, the intensity of the beam increases (the illuminance increases). Therefore, as in this example, the light collecting surface of the second linear prism portion in the closest position to the base angle side of the first linear prism portion is enlarged, so that beams with higher intensity can be collected. For the above-described reason, the optical control sheet for use in the liquid crystal display according to Inventive Example 2 can improve the use efficiency of incident light and thus the luminance of output light.

On the other hand, the second sectional portion 23a is positioned on the side of the vertical angle 21e of the first sectional portion 21a. The second sectional 23a is approximately triangular as shown in FIG. 4. The second sectional portion 23a has a base 23b and inclined sides 23c and 23d. The base 23b is abutted on and parallel to the inclined side 21c (second side) of the first sectional portion 21a. The inclined sides 23c and 23d extend at prescribed angles (α₂ and β₃ in FIG. 4), respectively from both ends of the base 23b. The inclined side 23d is positioned on the side of the vertical angle 21e of the first sectional portion 21a. The inclined side 23d has two sides 23f ad 23g. The inclined side 23d has a shaped bent in a raised form to the outside of the second sectional portion 23a.

The side 23f is positioned on the side of the inclined side 21d of the first sectional portion 21a. As shown in FIG. 4, the side 23f extends parallel to the inclined side 21d from the vertex of the vertical angle 21e. Therefore, the angle β₃ (second base angle) between the base 23b and the inclined side 23d of the second sectional portion 23a equals α₁+β₁. The side 23g is parallel to the inclined side 22d of the second sectional portion 22a. In this example, the inclined side 23c is parallel to the inclined side 22c. The side 23f is parallel to the inclined side 21d. The side 23g is parallel to the inclined side 22d. The angle α₂ of the first base angle of the second sectional portion 23a is 30° and the angle β₃ of the second base angle of the second sectional portion 23a is 96.85°.

In the second linear prism portion having the second sectional portion 23a, the surface including the inclined side 23c is a light collecting surface. The surface including the side 23f is parallel to the surface including the inclined side 21d. Therefore, the inclination direction of the surface including the side 23f is approximately parallel to the luminance peak beam 52. The surface including the side 23f less affects the refraction and reflection of incident light.

In the second linear prism portion having the second sectional portion 23a, the surface including the side 23g is a correction surface. Therefore, in this example, the second linear prism portion having the second sectional portion 23a has such a shape that the area of the light collecting surface is as large as possible and the correction surface is as small as possible.

The optical control sheet in this example was also evaluated for its optical characteristics similarly to Inventive Example 1. More specifically, the optical control sheet in this example was mounted to the evaluation device shown in FIG. 13. In other words, the optical control sheet in this example was mounted instead of the optical control sheet 1 in Inventive Example 1 in FIG. 13. Using a luminance meter, the front luminance of the evaluation device according to Inventive Example 2 was measured. Sensory evaluation of tints was carried out by visual inspection. Note that the polarizing plate on the side of the optical control member of the liquid crystal display according to Inventive Example 2 was arranged in a direction to transmit a P-polarized component of light.

For the purpose of comparison, the following evaluation device according to Comparative Example 3 was produced. The evaluation device according to Comparative Example 3 had a polarizing plate 7j arranged to transmit an S-polarized component instead of the polarizing plate 7a in the evaluation device according to Inventive Example 2. The other structure was the same as that of Inventive Example 2.

The results of evaluation are given in Table 1. As can be clearly understood from Table 1, the front luminance of the evaluation device according to Inventive Example 2 was 134% which was even higher than the result of Inventive Example 1 (128%). As described above, this was probably because in the optical control sheet according to Inventive Example 2, the light collecting surface of the second linear prism portion (the second linear prism portion corresponding to the second sectional portion 22a) positioned closest to the base angle of the first linear prism portion among the plurality of second linear prism portions that constitute the linear optical structure had a larger area than the corresponding light collecting surface of the second linear prism portion according to Inventive Example 1. As described above, in the optical control sheet according to Inventive Example 2, the correction surface of the second linear prism portion (corresponding to the second sectional portion 23a) positioned on the side of the vertical angle 21e had a smaller area. However, as in Table 1, no significant difference was observed between Inventive Examples 1 and 2 as for color homogeneity. More specifically, it was found that when the optical control sheet according to Inventive Example 2 is used in various kinds of illumination device including a backlight unit for liquid crystal, sufficient optical characteristics is obtained. On the other hand, in the evaluation device according to Comparative Example 3, the front luminance was lower than that of the evaluation device according to Inventive Example 2. The effect of reducing color separation was also reduced.

Number of Second Linear Prism Portions

As described above, the optical control member for use in the liquid crystal display according to the present invention includes a base and a plurality of linear optical structures formed on the base and having optical transparency. The linear optical structure has an approximately triangular section orthogonal to its extending direction. A cross section of the linear optical structure is defined by three sides. On of the three sides was abutted on and parallel to the surface of the base. One of the other two sides has a stepped shape. The stepped side consists of a plurality of triangular portions. The triangular portions each have two sides on both sides of the vertical angle. One of the sides refracts an incident beam inclined to the base portion of the base so that the beam advances in an orthogonal direction to the base. The other side reduces color separation.

The polarizing plate (polarizing plate 7a in FIG. 3) of the liquid crystal display panel on the side of the optical control member is arranged in a direction to transmit a P-polarized component. In this case, the front luminance improves and the effect of reducing color separation improves as compared to the case of arranging it in a direction to transmit an S-polarized component.

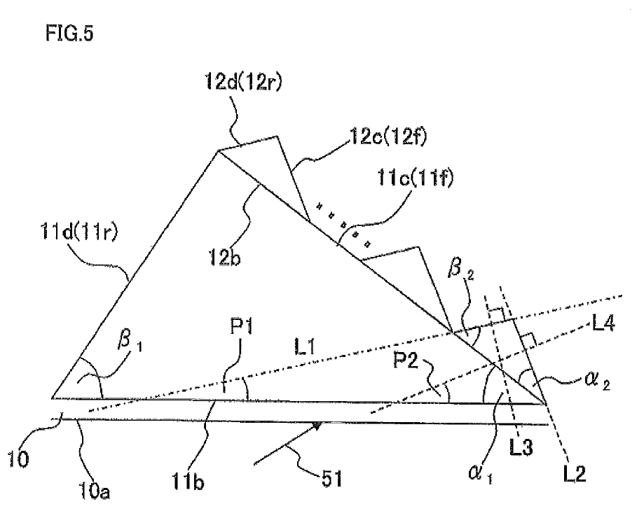

The number of steps at the stepped inclined surface of the linear optical structure (i.e., the number of the second linear prism portions in one linear optical structure) is preferably from 1 to 15, more preferably from 2 to 9. As shown in FIG. 5, the inventors produced a plurality of optical control sheets in which the number of second linear prism portions varied from 1 to 15 (Inventive Examples 3 to 9 and Comparative Examples 6 to 12). The second linear prism portions of the optical control sheets each have a first base angle α₂ of 30° and a second base angle β₂ of 70°. The second prism portion is provided on the surface including the side 11c. The second linear prism portions of the optical control sheets all had the same shape. In addition, the first prism portions of the optical control sheets all had a first base angle α₁, 39.14° and a second base angle β₁, 57.71°. The bases 11b of the first linear prism portions each have a length of 35 μm. In the following description of inventive embodiments and comparative examples, the size of the second prism portions was changed similarly as required depending on the number of the second linear prism portions provided on and in contact with the side 11c. Now, evaluation devices corresponding to liquid crystal displays according to Inventive Examples 3 to 9 and Comparative Examples 6 to 12 will be described in detail.

### Inventive Example 3

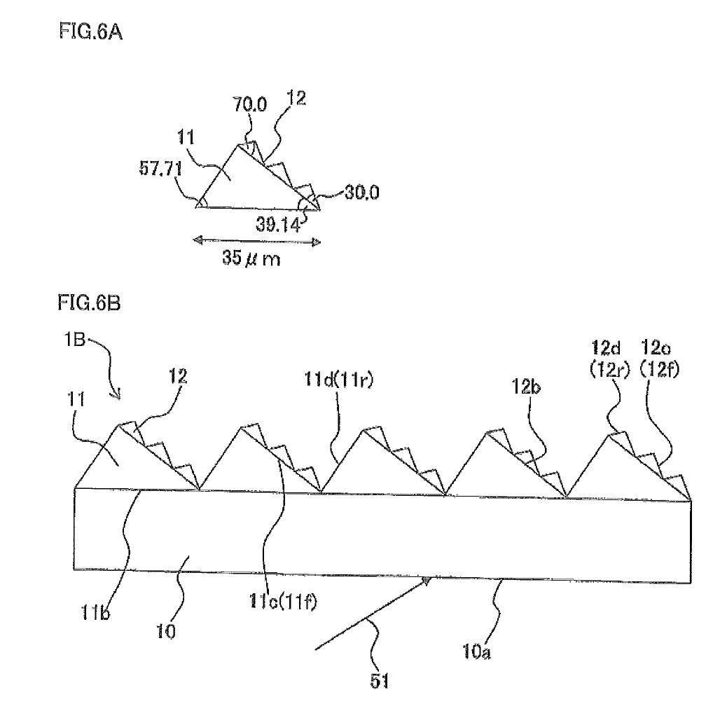

As shown in FIGS. 6A and 6B, an optical control member 1B for use in the liquid crystal display according to Inventive Example 3 has three second linear prism portions 12 provided on each of the first linear prism portions 11. More specifically, there were three approximately triangular shaped structures that form the second sectional portion. In an evaluation device according to Inventive Example 3, a polarizing plate 7a was laid on the optical control member 1B to transmit a P-polarized component. The other structure was the same as that of Inventive Example 1.

Similarly to Inventive Examples 1 and 2, the front luminance of the evaluation device according to Inventive Example 3 was measured and sensory evaluation of tints was carried out. The front luminance was very high (not less than 120%) in Inventive Example 3. The effect of reducing color separation was sufficient. The coloring of output light was not recognized by visual inspection.

### Inventive Example 4

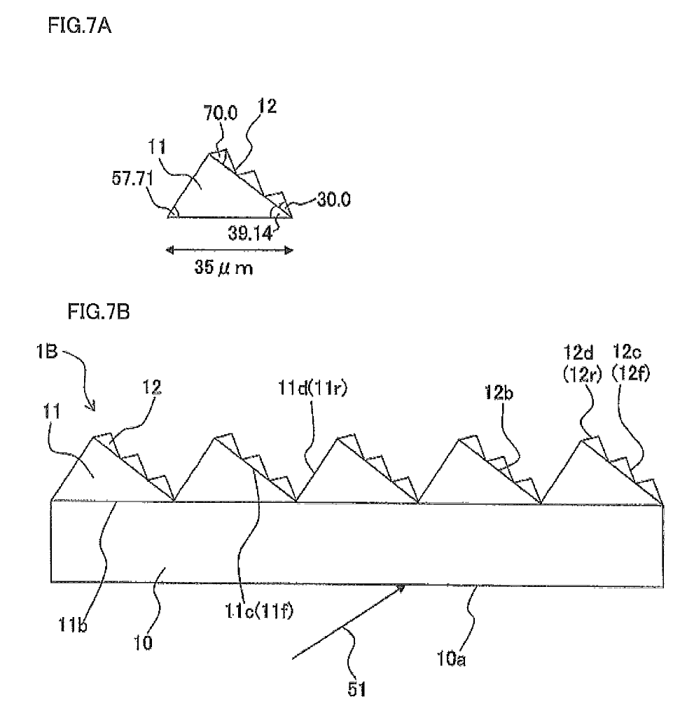

As shown in FIGS. 7A and 7B, in an optical control member 1C for use in a liquid crystal display according to Inventive Example 4, two second linear prism portions 12 are provided on the inclined side 11c of each of the first prism portions 11. More specifically, there were two approximately triangular structures that form the second sectional portion. In the evaluation device according to Inventive Example 4, the polarizing plate 7a arranged in a direction to transmit a P-polarized component of light was laid on the optical control member 1C similarly to Inventive Example 3. The other structure of the evaluation device according to Inventive Example 4 was the same as that of Inventive Example 3.

Similarly to Inventive Examples 1 and 2, the front luminance of the evaluation device according to Inventive Example 4 was measured and sensory evaluation of tints was carried out. The front luminance of the evaluation device according to Inventive Example 4 was very high (not less than 120%). The effect of reducing color separation was sufficient, and the coloring of output light was not recognized by visual inspection. In Inventive Example 4, the correction surface was positioned closer to the base angle α₁ than Inventive Example 7 that will be described. As a result, high front luminance and high color separation reducing effect were both obtained (In Inventive Example 2, the light collecting surface and the correction surface were balanced with the structure. In Inventive Example 2, the two second linear prism portions have different shapes for control.)

### Inventive Example 5

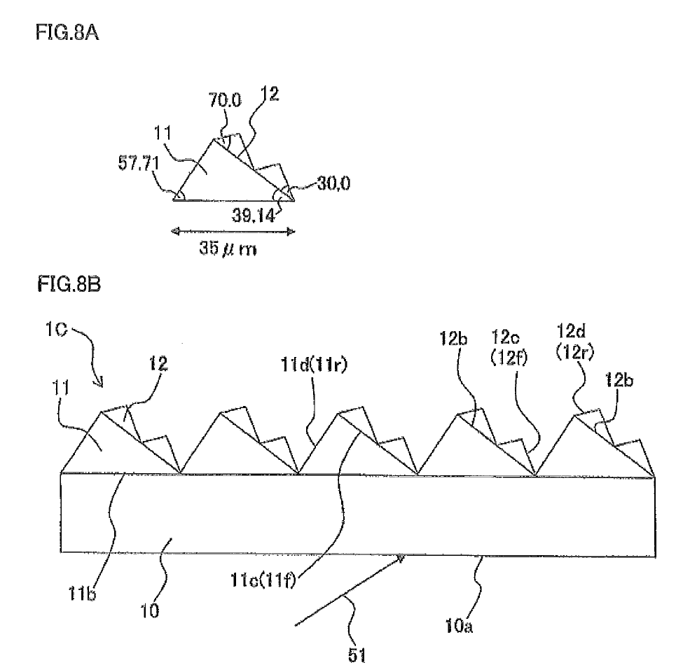

As shown in FIGS. 8A and 8B, in an optical control member 1D for use in a liquid crystal display according to Inventive Example 5, six second linear prism portions 12 were provided on the inclined side 11c of each of the first linear prism portions 11. More specifically, there were six approximately triangular structures that form the second sectional portion. In an evaluation device according to Inventive Example 5, a polarizing plate was arranged in a direction to transmit a P-polarized component of light similarly to Inventive Example 3. More specifically, the polarizing plate 7a was used. The front luminance of the evaluation device according to Inventive Example 5 was measured and sensory evaluation of tints was carried out. The front luminance was very high (not less than 120%) in Inventive Example 5. The effect of reducing color separation was sufficient and the coloring of output light was not recognized by visual inspection.

### Inventive Example 6

In an optical control member (not shown) for use in a liquid crystal display according to Inventive Example 6, nine second linear prism portions are provided on the inclined side of each of the linear prism portions. More specifically, there were nine approximately triangular structures that form the second sectional portion. In an evaluation device according to Inventive Example 6, the polarizing plate was arranged in a direction to transmit a P-polarized component of light similarly to Inventive Example 3. More specifically, the polarizing plate 7a was used. The front luminance of the evaluation device according to Inventive Example 6 was measured and sensory evaluation of tints was carried out. The front luminance was very high (not less than 120%) in Inventive Example 6. The effect of reducing color separation was sufficient and the coloring of output light was not recognized by visual inspection.

### Inventive Example 7

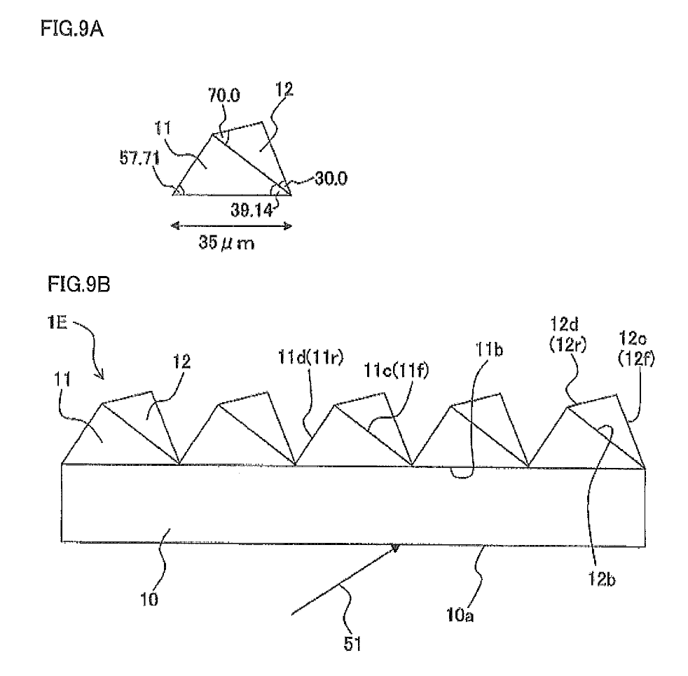

As shown in FIGS. 9A and 9B, in a optical control member 1E for use in a liquid crystal display according to Inventive Example 7, one second linear prism portion 12 was provided on the inclined side 11c of the first linear prism portion 11. More specifically, there was one approximately triangular structure that forms the second sectional portion. Note that in an evaluation device according to Inventive Example 7, the polarizing plate was arranged in a direction to transmit a P-polarized component of light similarly to Inventive Example 3. More specifically, the polarizing plate 7a was used. The front luminance of the evaluation device according to Inventive Example 7 was measured and sensory evaluation of tints was carried out. The front luminance was very high and not less than 120% in Inventive Example 7. With the optical control member IE for use in the liquid crystal display according to Inventive Example 7, the effect of reducing color separation was not sufficient and the coloring of output light was recognized by visual inspection. However, the degree of the coloring of the output light recognized in Inventive Example 7 was smaller than the degree of the coloring in Comparative Example 2 described above.

The results were probably for the following reasons. As described above, when the light collecting surface of the secondary linear prism portion positioned closest to the base angle (the α₁ side) of the first linear prism portion 11 has a large area, the use efficiency of incident light increases, which increases the luminance. The second linear prism portion forming surface 11c of the first linear prism portion 11 has a larger opening angle to the base surface as it is closer to the side of the base angle α₁. Therefore, the intensity of a beam transmitted through the surface 11c increases toward the base angle α1 of the first linear prism portion (the illuminance increases).

When one second linear prism portion is provided on the first linear prism portion 11 as in Inventive Example 7, the light collecting surface of the second linear prism portion positioned on the α₁ side is maximized. Therefore, beams with high intensity can be collected, so that the use efficiency of incident beams can be improved, which increases the luminance of output light. On the other hand, beams transmitted through the correction surface are relatively reduced. Therefore, the effect of reducing color separation is not sufficient. Consequently, the coloring of the output light remains. Since beams transmitted through the correction surface are reduced relatively, the effect of scattering the output angle by the correction surface is not sufficient. As a result, the viewing angle is reduced. In Inventive Example 7, the luminance of the peak of the output light was sufficient, while it was not arranged in a direction to the front. Since the viewing angle is small, the front luminance was smaller than those of the optical control members in Inventive Examples 3 to 5 described above.

### Inventive Example 8

An optical control member for use in a liquid crystal display according to Inventive Example 8 (not shown) had ten second linear prism portions provided on an inclined side of the first linear prism portion. More specifically, the optical control member according to Inventive Example 8 had ten approximately triangular structures that form the second sectional portion at each of the linear optical structures. Note that a polarizing plate for use in an evaluation device according to Inventive Example 8 was arranged in a direction to transmit a P-polarized component of light. The front luminance was not less than 100% in Inventive Example 8. The effect of color separation was sufficient and the coloring of output light was not recognized by visual inspection.

### Inventive Example 9

An optical control member for use in a liquid crystal display according to Inventive Example 9 (not shown) had 15 second linear prism portions provided on a inclined side of the first linear prism portion. More specifically, the optical control member according to Inventive Example 9 had 15 approximately triangular structures that form the second sectional portion at each of the linear optical structures. Note that a polarizing plate for use in an evaluation device according to Inventive Example 9 was arranged in a direction to transmit a P-polarized component of light. In Inventive Example 9, the front luminance was not less than 100%. The effect of color separation was sufficient and the coloring of output light was not recognized by visual inspection.

In Inventive Examples 8 and 9, the area of the correction surface of the second linear prism portion provided nearer to the first base angle α₁ was greater. However, the area of the light collecting surface was relatively small. As a result, the effect of reducing color separation was sufficient. The front luminance was not less than 100% but slightly lower than those in Inventive Examples 3 to 6.

### Comparative Example 4

Unlike the evaluation device according to Comparative Example 1, in an evaluation device according to Comparative Example 4 (not shown), a polarizing plate was arranged in a direction to transmit an S-polarized component of light. More specifically, the polarizing plate 7j was used instead of the polarizing plate 7a. The other structure was the same as that in Comparative Example 1. The front luminance of the evaluation device according to Comparative Example 4 was measured and sensory evaluation of tints was carried out. In Comparative Example 4, the polarizing plate was arranged in a direction to transmit an S-polarized component of light, so that the effect of color separation was sufficient while the front luminance was lower than that in Comparative Example 1.

### Comparative Example 5

Unlike the evaluation device according to Comparative Example 2, in an evaluation device according to Comparative Example 5, a polarizing plate was arranged in a direction to transmit an S-polarized component of light. More specifically, the polarizing plate 7j was used instead of the polarizing plate 7a. The other structure was the same as that in Comparative Example 2. In Comparative Example 5, the polarizing plate was arranged in a direction to transmit an S-polarized component of light, so that the front luminance was even lower than that in Comparative Example 2. The effect of reducing color separation was not sufficient similarly to Comparative Example 2.

### Comparative Example 6

Unlike Inventive Example 7, in an evaluation device (not shown) according to Comparative Example 6, a polarizing plate was arranged in a direction to transmit an S-polarized component of light. More specifically, the polarizing plate 7j was used instead of the polarizing plate 7a. The other structure was the same as that of Inventive Example 7. In Inventive Example 6, the polarizing plate was arranged in a direction to transmit an S-polarized component of light. As a result, the front luminance was even more lowered as compared to Inventive Example 7. The effect of reducing color separation was not sufficient similarly to Inventive Example 7.

### Comparative Example 7

In an evaluation device (not shown) according to Comparative Example 7, a polarizing plate was arranged in a direction to transmit an S-polarized component of light unlike Inventive Example 4. More specifically, the polarizing plate 7j was used instead of the polarizing plate 7a. The other structure was the same as that of Inventive Example 4. In Comparative Example 7, the polarizing plate was arranged in a direction to transmit an S-polarized component of light, so that the front luminance was lower than that in Inventive Example 4. The effect of color separation was lower than that in Inventive Example 4.

### Comparative Example 8

In an evaluation device according to Comparative Example 8 (not shown), a polarizing plate was arranged in a direction to transmit the S-polarized component of light unlike Inventive Example 3. More specifically, the polarizing plate 7j was used instead of the polarizing plate 7a. The other structure was the same as that of Inventive Example 3. In Comparative Example 8, the polarizing plate was arranged in a direction to transmit an S-polarized component of light, so that the front luminance was lower than that of Inventive Example 3. The effect of reducing color separation was lower than that of Inventive Example 3.

### Comparative Example 9

In an evaluation device according to Comparative Example 9 (not shown), a polarizing plate was arranged in a direction to transmit an S-polarized component of light unlike Inventive Example 5. More specifically, the polarizing plate 7j was used instead of the polarizing plate 7a. The other structure was the same as that of Inventive Example 5. In Comparative Example 9, the polarizing plate was arranged in a direction to transmit an S-polarized component of light, so that the front luminance was lower than that of Inventive Example 5. The effect of reducing color separation was lower than that of Inventive Example 5.

### Comparative Example 10

In an evaluation device according to Comparative Example 10 (not shown), a polarizing plate was arranged in a direction to transmit an S-polarized component of light unlike Inventive Example 6. More specifically, the polarizing plate 7j was used instead of the polarizing plate 7a. The other structure was the same as that of Inventive Example 6. In Comparative Example 10, the polarizing plate was arranged in a direction to transmit an S-polarized component of light and, so that the front luminance was lower than that of Inventive Example 6. The effect of reducing color separation was lower than that of Inventive Example 6.

### Comparative Example 11

In an evaluation device according to Comparative Example 11 (not shown), a polarizing plate was arranged in a direction to transmit an S-polarized component of light. More specifically, the polarizing plate 7j was used instead of the polarizing plate 7a. The other structure was the same as that of Inventive Example 8. In Comparative Example 11, the polarizing plate was arranged in a direction to transmit an S-polarized component of light, so that the front luminance was lower than that of Inventive Example 8 (less than 100%). The effect of reducing color separation was even lower than that of Inventive Example 8.

### Comparative Example 12

In an evaluation device according to Comparative Example 12 (not shown), a polarizing plate was arranged in a direction to transmit an S-polarized component of light. More specifically, the polarizing plate 7j was used instead of the polarizing plate 7a. The other structure was the same as that of Inventive Example 9. In Comparative Example 12, the polarizing plate was arranged in a direction to transmit an S-polarized component of light, so that the front luminance was lower than that of Inventive Example 9 (less than 100%). The effect of reducing color separation was even lower than that of Inventive Example 9.

The above-described evaluation results were given in Table 2. Note that as for the front luminance, the front luminance of Comparative Example 4 is set as a reference (100%). Criterion for evaluating color homogeneity in Table 2 are the same as those in Table 1. Note that in the column of color homogeneity evaluation, “Δ” indicates that difference in tint can be more clearly recognized than “∘” but less clearly than “x.”

TABLE 2

| | | | | | | | Direction | | | Color |
|---|---|---|---|---|---|---|---|---|---|---|
| | | | | | | | of | Front luminance | | homogeneity |
| | | | | | | Number | polarizing | (through | | (through |
| | | α₁ | β₁ | α₂ | β₂ | of steps | plate | polarizing plate) | | polarizing plate) |
| Comparative | 2 prism | — | — | — | — | — | P | 108 | ◯ | ◯ |
| Example 1 | sheets | | | | | | | | | |
| Comparative | 2 prism | — | — | — | — | — | S | 100 | Δ | ◯ |
| Example 4 | sheets | | | | | | | | | |
| Comparative | 1 prism | — | — | — | — | — | P | 88 | X | X |
| Example 2 | sheet | | | | | | | | | |
| Comparative | 1 prism | — | — | — | — | — | S | 73 | X | X |
| Example 5 | sheet | | | | | | | | | |
| Inventive | — | 39.14 | 57.71 | 30 | 70 | 1 | P | 122 | ⊚ | Δ |
| Example 7 | | | | | | | | | | |
| Comparative | — | 39.14 | 57.71 | 30 | 70 | 1 | S | 102 | ◯ | Δ |
| Example 6 | | | | | | | | | | |
| Inventive | — | 39.14 | 57.71 | 30 | 70 | 2 | P | 127 | ⊚ | ⊚ |
| Example 4 | | | | | | | | | | |
| Comparative | — | 39.14 | 57.71 | 30 | 70 | 2 | S | 106 | ◯ | ◯ |
| Example 7 | | | | | | | | | | |
| Inventive | — | 39.14 | 57.71 | 30 | 70 | 3 | P | 128 | ⊚ | ⊚ |
| Example 3 | | | | | | | | | | |
| Comparative | — | 39.14 | 57.71 | 30 | 70 | 3 | S | 107 | ◯ | ◯ |
| Example 8 | | | | | | | | | | |
| Inventive | — | 39.14 | 57.71 | 30 | 70 | 6 | P | 127 | ⊚ | ⊚ |
| Example 5 | | | | | | | | | | |
| Comparative | — | 39.14 | 57.71 | 30 | 70 | 6 | S | 106 | ◯ | ◯ |
| Example 9 | | | | | | | | | | |
| Inventive | — | 39.14 | 57.71 | 30 | 70 | 9 | P | 122 | ⊚ | ⊚ |
| Example 6 | | | | | | | | | | |
| Comparative | — | 39.14 | 57.71 | 30 | 70 | 9 | S | 102 | ◯ | ◯ |
| Example 10 | | | | | | | | | | |
| Inventive | — | 39.14 | 57.71 | 30 | 70 | 10 | P | 118 | ◯ | ⊚ |
| Example 8 | | | | | | | | | | |
| Comparative | — | 39.14 | 57.71 | 30 | 70 | 10 | S | 98 | Δ | ◯ |
| Example 11 | | | | | | | | | | |
| Inventive | — | 39.14 | 57.71 | 30 | 70 | 15 | P | 108 | ◯ | ⊚ |
| Example 9 | | | | | | | | | | |
| Comparative | — | 39.14 | 57.71 | 30 | 70 | 15 | S | 90 | X | ◯ |
| Example 12 | | | | | | | | | | |

As in the foregoing, a relatively high front luminance (not less than 100%) and reduction in color separation are both obtained when the number of second linear prism portions, in other words, the number of approximately triangular structures that constitute the second sectional portion is from one to nine. Stated differently, a very high front luminance (not less than 120%) and great reduction in color separation are both obtained when the number of approximately triangular structures that constitute the second sectional portion is from two to nine. The number of steps at the stepped surface 13b of the linear optical structure 13 is particularly preferably from two to nine. Furthermore, in the liquid crystal display panel, when the polarizing plate on the side of the optical control means is arranged in a direction to transmit a P-polarized component of light, the front luminance can be improved as compared to the case of arranging the polarizing plate in a direction to transmit an S-polarized component of light. In addition, the effect of reducing color separation can be improved.

In the above-described examples, as for the sizes of the base angles α₁, β₁, α₂, and β₂, particular combinations are described by way of illustration. However, when the incident angle of a luminance peak beam is in the range from 45° to 85°, the same results were obtained as a result of a plurality of experiments in optical control members that satisfy the following expression. In the following expression, the refractive index no of air is 1.0 and the unit of angle is degree.

n₀ sin I₁=n₁ sin I₂

0≦sin(α₁+α₂−I₂)≦1/n₁

I₂<α₁+α₂≦I₂+90

−I₂<β₂−α₁≦90−I₂ (1)

In this way, a luminance peak beam with the highest luminance can be refracted without being totally reflected by the light collecting surface. The luminance peak beam can be extracted efficiently from the optical control sheet.

When I₂ₘₐₓ is a critical angle for total reflection, in other words, when sin I₂ₘₐₓ=1/n₁, the same result was obtained from a plurality of experiments carried out in an optical control member that satisfied the following expression.

α₁+α₂≦2·I₂ₘₐₓ (2)

In this way, when an incident beam has an angular distribution whose peak is the angle of the luminance peak beam, an incident bream at an arbitrary incident angle can be extracted efficiently from the optical control sheet without totally reflecting the beam by the light collecting surface.

In this way, with the optical control sheet having a combination of angles that satisfies the above-described conditions for angles, color separation is reduced and the luminance characteristic is improved. The total reflection of an incident beam by the light collecting surface is reduced. As a result, a beam can be taken out from the optical control sheet efficiently. Note that the optical control sheet according to the present invention does not always have to satisfy the above-described angle conditions, and the present invention can be applied to an optical control sheet having an arbitrary combination of angles.

Note that in the above description of the examples, the optical control sheet has the first and second linear prism portions having a prescribed size. For example in the above-described Inventive Examples 3 to 6, the base portion lib of the first linear prism in contact with the base of the optical control sheet is 35 μm but the invention is not limited to this. For example, even when the base portion lib has a length in the range from 7 μm to 100 μm, both a high front luminance and great reduction in color separation can be obtained as far as the number of the plurality of approximately triangular structures that form the second sectional portion is from two to nine.

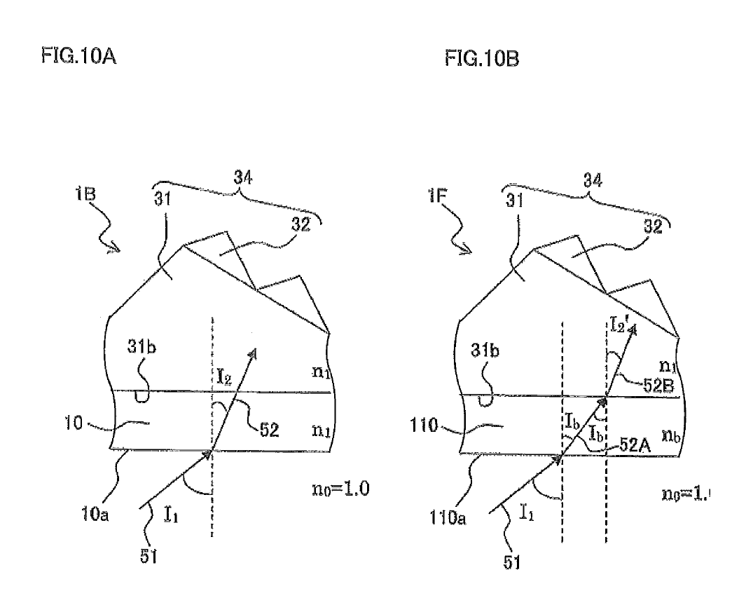

In the foregoing description, the base of the optical control sheet and the linear optical structure are both formed using an optical material with a refractive index n₁, but the invention is not limited to this. The refractive index n_{b} of the base of the optical control sheet may be different from the refractive index n₁ of the linear optical structure. The optical control sheet 1B in Inventive Example 3 shown in FIG. 10A has the base 10 and the linear optical structure 34 both formed using an optical material with the refractive index n₁. On the other hand, the optical control sheet 1F shown in FIG. 10B has the linear optical structure 34 formed using an optical material with the refractive index n₁ and a base 110 formed using an optical material with the refractive index n_{b}(n_{b}≠n₁).

As described above, in FIG. 10A, the beam 51 enters the base 10a of the base 10 (the interface with the air) at an incident angle I1 and is refracted at the base 10a. The refraction angle I2 here is represented by Expression 3 as follows (the Snell's law).

sin I₂=(sin I₁)/n₁ (3)

The base 10 and the linear structure 34 are formed using the optical materials with the same refractive index n₁. Therefore, a beam 52 moving inside the base 10 advances straight forward without being refracted at the interface between the base 10 and the first prism portion 31 (the surface including the base 31b) of the linear structure 34.

On the other hand, in FIG. 10B, the beam 51 entered into the base 110a of the base 110 (the interface with the air) at an incident angle I1 is refracted at the base 110a. The refraction angle Ib here is represented by the following Expression 4.

sin I_{b}=(sin I₁)/n_{b} (4)

The base 110 (with the refractive index n_{b}) and the linear structure 34 (with the refractive index n₁) are formed using materials with different refractive indexes. Therefore, the beam 52A advancing in the base 110 is refracted at the interface between the base 110 and the first linear prism portion 31 (the surface including the base 31b). Here, when the upper and lower surfaces are parallel to each other like the base 110 shown in FIG. 10B, the refraction angle I₂′ at the interface between the base 110 and the first linear prism portion 31 is represented by the following Expression 5.

sin I_{2′}=(n_{b}/n₁)sin I_{b} (5)

Substituting Expression 4 in Expression 5 yields sin I₂′=(sin I₁)/n₁. This is the same as Expression 3. As can be seen, I₂′ equals the refraction angle I₂ when a beam enters directly from the air into a medium with a refractive index n₁. Therefore, when the refractive indexes of the base and the linear structure are different as in the optical control sheet 1F, the linear structure may have n₁ as a refractive index for the linear structure and I₂ as the refraction angle at the interface between the base and the linear structure, so that the expressions in the above description can be applied as they are.

Although the present invention has been described and illustrated in detail, it is clearly understood that the same is by way of illustration and example only and is not to be taken by way of limitation. The described embodiments can be subjected to various modifications without departing the scope and spirit of the present invention.

### INDUSTRIAL APPLICABILITY

The optical control member for use in the liquid crystal display according to the present invention is a single optical control member that can reduce color separation of output light and improve the use efficiency of incident light. Therefore, the optical characteristics can be improved while the device is reduced in thickness and cost. The member is particularly suitably applied as an optical member capable of controlling the optical directivity of an edge light illumination device and a liquid crystal display.

In the liquid crystal display according to the invention, the polarizing plate on the side of the optical control member (on the side of light incident surface) in the liquid crystal display panel is arranged in a direction to transmit a P-polarized component. Therefore, the front luminance of light output from the liquid crystal display panel can be improved and the effect of reducing color separation can be improved as compared to when the polarizing plate on the side of the optical control member is arranged in a direction to transmit an S-polarized component. Therefore, the liquid crystal display according to the present invention is suitably applied for various kinds of uses.

1. A liquid crystal display, comprising:
a light source;
an optical control member optically connected to said light source, said optical control member comprising a base having a light incident surface to which light from said light source is entered and having optical transparency and a plurality of linear structures provided on a surface of said base on an opposite side to said light incident surface and having optical transparency;
a section orthogonal to an extending direction of the linear structure including a first sectional portion in a triangular shape defined by first to third sides and a second sectional portion in an approximately triangular shape having a smaller area than that of said first sectional portion and defined by fourth to sixth sides, the first side of said first sectional portion being abutted on and parallel to the surface of said base on the opposite side to said light incident surface and said second sectional portion being provided on the second side of the first sectional portion, the fourth side of said second sectional portion being abutted on and parallel to the second side of the first sectional portion, an angle formed between the first and second sides of said first sectional portion being smaller than an angle formed between the first and third sides; and
a liquid crystal display element having a first polarizing element, a liquid crystal layer, and a second polarizing element provided opposed to said plurality of linear structures of said optical control member and being layered on one another in this order,
the first polarizing element being arranged in a direction to transmit a P-polarized component predominantly.

2. The liquid crystal display according to claim 1, further comprising a light guiding panel that guides light from said light source to said light control member, wherein said light source is provided at an end of said light guiding panel.

3. The liquid crystal display according to claim 1, wherein each said linear structure comprises a plurality of triangular structures that define said second sectional portion,
said plurality of triangular structures are provided on the second side of the first sectional portion with no gap therebetween, and
the number of said triangular structures is from two to nine.

4. The liquid crystal display according to claim 3, wherein one of the fifth and sixth sides of said plurality of triangular shapes closer to a vertical angle opposed to the first side of said first sectional portion is shorter than the other side.

5. The liquid crystal display according to claim 3, wherein when a luminance peak beam that advances in a direction in which a luminance is maximized in a luminance characteristic of a beam entered into said optical control member is refracted, the fifth and sixth sides of said triangular structure are inclined with respect to the fourth side so that an advancing direction of the luminance peak beam after being refracted by a surface of said linear structure including the fifth side of said triangular structure and a advancing direction of the luminance peak beam after being refracted by a surface of said linear structure including the sixth side of said triangular structure are reversed from each other with respect to an advancing direction of the luminance peak beam before being refracted.

6. The liquid crystal display according to claim 1, wherein an inclination direction of the third side of said first sectional portion with respect to the first side is approximately parallel to a direction in which a luminance is maximized in the luminance characteristic of the beam input to said optical control member.

7. The liquid crystal display according to claim 1, wherein said plurality of linear structures are provided in a direction orthogonal to the extending direction.

8. The liquid crystal display according to claim 1, wherein when said linear structure has a refractive index n₁, air surrounding said base and said linear structure has a refractive index n₀ that is 1.0, an angle formed between a direction normal to an interface between said air and said base and said beam's direction in said air is I₁, an angle formed between said normal direction and said beam's direction in said linear structure is I₂, and angles formed between the first and second sides, the fourth and fifth sides, and the fourth and sixth sides are α₁, α₂, and β₂, respectively, the following expression is satisfied:
n₀ sin I₁=n₁ sin I₂
0≦sin(α₁+α₂−I₂)≦1/n₁
I₂<α₁+α₂≦I₂+90
−I₂<β₂−α₁≦90−I₂.

9. The liquid crystal display according to claim 1, wherein when said linear structure has a refractive index n₁, a critical angle for total reflection of said beam at an interface between air surrounding said base and said linear structure and said linear structure is I₂ₘₐₓ, sin I₂ₘₐₓ=1/n₁ is satisfied, and angles formed between the first and second sides and the fourth and fifth sides are α₁ and α₂, respectively, the following expression is satisfied:
α₁+α₂≦2·I₂ₘₐₓ.

10. A liquid crystal display, comprising:
a light source; and
an optical control member optically connected to said light source, said optical control member comprising a base having a light incident surface to which light is entered and having optical transparency and a plurality of linear structures provided on a surface of said base on an opposite side to said light incident surface and having optical transparency, each said linear structure having a light collecting surface and a correction surface,
a section of said linear structure orthogonal to its extending direction being approximately triangular, one of three sides defining said section being abutted on and parallel to the surface of said base on an opposite side to said light incident surface, one of the other two sides being stepped, said stepped side being a line intersection between said section and said light collecting surface and said correction surface, an angle formed between a side of said section parallel to said base and said stepped side of said section being smaller than an angle formed between the side parallel to said base and a remaining side; and
a liquid crystal display element having a first polarizing element, a liquid crystal layer, and a second polarizing element provided opposed to said plurality of linear structures of said optical control member and being layered on one another in this order,
the first polarizing element being arranged in a direction to transmit a P-polarized component predominantly.

11. The liquid crystal display according to claim 10, further comprising a light guiding panel that guides light from said light source to said optical control member, said light source being provided at an end of said light guiding panel.

12. The liquid crystal display according to claim 1, wherein said base has a refractive index equal to that of said linear structure.

13. The liquid crystal display according to claim 1, wherein said base has a refractive index different from that of said linear structure and is formed to have a parallel plate shape.

14. The liquid crystal display according to claim 2, further comprising a reflection member provided on an opposite side to said optical control member of said light guiding panel.
